(19) United States
(12) Patent Application Publication
(10) Pub. No.: US 2024/0236709 A1
(43) Pub. Date: Jul. 11, 2024

(54) METHODS AND APPARATUS FOR DETERMINING AND/OR USING KPIs IN WIRELESS SYSTEMS

(71) Applicant: Charter Communications Operating, LLC, St. Louis, MO (US)

(72) Inventor: Saran Khalid, Denver, CO (US)

(21) Appl. No.: 18/095,744

(22) Filed: Jan. 11, 2023

(51) Int. Cl. H04W 24/02; H04L 67/148; H04M 3/22

(52) U.S. Cl. CPC H04W 24/02; H04L 67/148; H04M 3/2218

(57) ABSTRACT

The present invention relates to methods and apparatus for determining and/or using Key Performance Indictors, e.g., session drops, in wireless systems. An exemplary embodiment includes operation of a correlator comprising the steps of: receiving from a cloud connection manager a plurality of user equipment snapshot data records corresponding to successful user equipment device migrations from a first wireless network to a second wireless network; receiving from a first network core first Operations Support System (OSS) data, the first OSS data including a first plurality of session data records; identifying one or more false session drops in the first OSS data using the plurality of user equipment snapshot data records and the first plurality of session data records; modifying the first OSS data to mark or remove in the first OSS data the identified false session drops; and communicating the modified first OSS data to the first network core.

### FIELD OF INVENTION

The present invention relates to methods and apparatus for determining and/or using Key Performance Indictors (KPIs) such as for example, session drops and/or session throughput drops, in wireless systems. The present invention further relates to methods and apparatus for providing connection manager cloud based KPI services for wireless systems. The present invention further relates to identifying ghost call drops in Hybrid Mobile Network Operator (HMNO) wireless systems. The present invention further relates to methods and apparatus that use geo-fencing for determining HMNO wireless system false call drops also referred to as ghost call drops during user equipment device communication session handoffs, transfers and/or migrations between wireless networks.

### BACKGROUND OF THE INVENTION

In a Hybrid Mobile Network Operator system the user equipment (UE) devices reside on both Mobile Virtual Network Operator and Multiple System Operator (MSO) networks. When the UE devices (e.g., mobile devices such as cell phones, smartphones, laptops, tablets) move from the MVNO network to the Mobile Network Operator (MNO) network and vice versa, these UE devices may appear to have disappeared from the network they were originally on/connected to suggesting poor performance and declined Key Performance Indicators (KPIs).

For example, when the UE devices on/connected to the MNO network move back to the MSO's network, it is perceived as poor performance as the MNO network will assume that there has been an unexpected call and/or data session drop and/or a drop in data throughput.

While the call/session and/or data throughput drops in such cases is not the result of bad performance but is the result of the transition/transfer of a UE from one wireless network to another wireless network, the two networks are operated independently of one another and do not have a way to identify that the call/session has actually been transferred as opposed to just dropped resulting in a false or ghost call drop. The Key Performance Indicator for call/session drops will incorrectly register this a dropped call/session on the wireless network from which the UE transferred. If only certain sessions, e.g., data session of a call, are dropped the KPI tracking data throughput will indicate poor performance in the location of the transfer when it is not a result of poor performance but is instead the result of transfers of session(s) from one network to another network.

From the foregoing, it should be understood that there is a need for new and/or improved methods and apparatus for determining and/or using KPIs such as session drops which are accurate for monitoring and/or optimizing wireless network performs. There is a further need for new and/or improved methods and apparatus for determining when a communications session has been successfully transferred to another wireless network instead of being labelled as dropped by the network from which it was transferred. There is a further need for new and/or improved methods and apparatus for accurately determining by HMNO operators KPIs relating to session which are transferred from a first wireless network to a second wireless network. There is a further need for new and/or improved methods and apparatus for avoiding unnecessary investigation into false communications session drops by a first wireless network when the communications sessions have been intentionally and successfully offloaded to a second independently operated wireless network. There is a further need for new and/or improved methods and apparatus for accurately and efficiently determining wireless network operational perform when communications session are transferred from the wireless network to another independently operated wireless network. There is a further need for new and/or improved methods and apparatus for automatically taking network operations to optimize network performance using accurate key performance indicator information taking into account successful offloading and/or transferring of sessions from a first wireless network to a second wireless network.

### SUMMARY OF THE INVENTION

The present invention provides new and/or improved methods and apparatus for determining and/or using accurate Key Performance Indicator information for monitoring and optimizing the performance of wireless systems which offload and/or migrate communications sessions from a first wireless network to a second wireless network. The present invention is particularly using for Hybrid Mobile Network Operators who have a MVNO network and a MSO network, the MVNO network operated on behalf of the Hybrid Mobile Network Operator by an independent Mobile Network Operation different than the Hybrid Mobile Network Operator. Various embodiments of the present invention solve one or more of the problems discussed above.

An exemplary communications method of in accordance with one embodiment of the present invention includes the steps of: receiving at a correlator from a cloud connection manager a plurality of user equipment snapshot data records corresponding to successful user equipment device migrations from a first wireless network to a second wireless network: receiving, by the correlator, from a first network core of a Hybrid Mobile Network Operator (HMNO) wireless system first Operations Support System (OSS) data, said first OSS data including a first plurality of session data records: identifying one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicating, by the correlator, the modified first OSS data to the first network core of the HMNO wireless system.

In various embodiments, each of said user equipment snapshot data records includes a timestamp, user equipment device identification information, session identification information, and location information.

In some embodiments, the first wireless network and second wireless network are operated independently by two different operators.

In some embodiments, the first wireless network is a Mobile Virtual Network Operator network operated by a first operator (e.g., Verizon) for a second operator (e.g., Charter): the second wireless network is a Multiple System Operator (MSO) network operated by the second operator: and the first wireless network and the second wireless network are operated independently.

In various embodiments, the communications method further includes successfully migrating a plurality of user equipment devices from the first wireless network to the second wireless network, said plurality of user equipment devices being Dual Subscriber Identity Module (SIM) Dual Subscriber (DSDS) user equipment devices with a first SIM and a first subscription for operating on the first wireless network and a second SIM and a second subscription for operating on the second wireless network.

In some embodiments, the step of successfully migrating a plurality of Dual Subscriber Identity Module (SIM) Dual Subscriber (DSDS) user equipment devices from the first wireless network to the second wireless network includes handing off or transferring active communications sessions for which a first wireless base station in the first wireless network is providing services to a second wireless base station in the second wireless network without dropping the communications session.

In some embodiments, the user equipment devices of the Hybrid Mobile Network Operator (HMNO) wireless system are Dual Subscriber Identity Module (SIM) Dual Subscriber (DSDS) user equipment devices with a first SIM and a first subscription allowing operation on the first wireless network and a second SIM and a second subscription allowing operation on the second wireless network, each of said DSDS user equipment devices including a connection manager coordinating transfers of the user equipment device communications sessions between the first wireless network and the second wireless network (e.g., transfers or handoffs from the first wireless network to the second wireless network and transfers or handoffs from the second wireless network to the first wireless network).

In various embodiments, the first wireless network is a Multiple System Operator (MSO) network operated by a first operator (e.g., Charter): the second wireless network is a Mobile Virtual Network Operator network operated by a second operator (e.g., Verizon) for the first operator (e.g., Charter); and the first wireless network and the second wireless network are operated independently.

In some embodiments, the first wireless network is a large cell wireless network and the second wireless network is a small cell wireless network: and a plurality of the cells of the second wireless network are encompassed by cells of the first wireless network.

In various embodiments, prior to the step of receiving at the correlator from the cloud connection manager the plurality of user equipment snapshot data records corresponding to successful user equipment device migrations from the first wireless network to the second wireless network, the method includes the steps of: determining by a first user equipment device a location of the first user equipment device with respect to a geofence surrounding the perimeter of the coverage area of first wireless network: generating a first user equipment snapshot data record at the first user equipment device: and transmitting the first user equipment snapshot data record from the first user equipment device to the cloud connection manager via the first wireless network and first core network.

In some embodiments, the communications method further includes prior to performing the step of receiving at the correlator from the cloud connection manager the plurality of user equipment snapshot data records corresponding to successful user equipment device migrations from the first wireless network to the second wireless network, performing the additional steps of: (i) generating a first user equipment snapshot data record at the first network core based on information (e.g., UE location and/or signaling information) received from a first user equipment device connected to a first base station of the first wireless network at a first time, said first user equipment snapshot data record being one of the plurality of user equipment snapshot data records corresponding to successful user equipment device migrations from the first wireless network to the second wireless network: and (ii) transmitting the first user equipment snapshot data record from the first network core to the cloud connection manager.

In some embodiments, the first user equipment snapshot data record is also generated based on first user equipment device profile information included in a first Home Subscriber Server (HSS) of the first network core.

In some embodiments, the first user equipment snapshot data record is also generated based on first user equipment device registration information included in the first Home Subscriber Server (HSS) of the first network core.

In some embodiments, the first user equipment snapshot data record is also generated based on first user equipment device connectivity information (e.g., session information, GUTI assigned by the MME or AMF to the first user equipment device) maintained in the first network core (e.g., in the Mobility Management Entity (MME) or Access and Mobility Function (AMF) of the first network core).

In some embodiments, prior to performing the step of generating the first user equipment snapshot data record at the first network core based on information (e.g., UE location and/or signaling information) received from the first user equipment device connected to the first base station of the first wireless network at the first time, the step of determining at the first network core to generate the first user equipment snapshot data record based on one or more of the following: location information received from the first user equipment device or signaling information received from the first user equipment device is performed.

In some embodiments, the step of determining at the first network core to generate the first user equipment snapshot data record based on one or more of the following: location information received from the first user equipment device or signaling information received from the first user equipment device includes: determining to generate the first user equipment snapshot data record when a first criteria is met.

In various embodiments, the first criteria is met when at least one of the following is true: the location information received from the first user equipment device indicates the first user equipment device is within a first distance (e.g., 10 feet) of a perimeter of the wireless coverage area of the second wireless network (e.g., a location indicating that the first user equipment device is about to enter the coverage of the second wireless network) or the signaling information (e.g., UE measured RSRP or RSRQ) received from the first user equipment device is below a first threshold level (e.g., a threshold level indicating that the first user equipment device is on the verge of being migrated to the second wireless network from the first wireless network).

In some embodiments, prior to performing the step of receiving at the correlator from the cloud connection manager a plurality of user equipment snapshot data records corresponding to successful user equipment device migrations from a first wireless network to a second wireless network, the following steps are performed: receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network: determining, at the cloud connection manager, which of the user equipment snapshot data records received from the first network core correspond to a successful user equipment device migration from the first wireless network to the second wireless network: and transmitting the plurality of user equipment snapshot data records corresponding to successful user equipment device migrations from the first wireless network to the second wireless network.

In some embodiments, the step of determining, at the cloud connection manager, which of the user equipment snapshot data records received from the first network core correspond to a successful user equipment device migration from the first wireless network to the second wireless network includes: determining a first user equipment snapshot data record for a first user equipment device corresponds to a successful first user equipment device migration from the first wireless network to the second wireless network when a first confirmation message indicating a successful migration from the first wireless network to the second wireless network has been completed is received at the cloud connection manager from the first user equipment device in a first period of time (e.g., 5 minutes after receipt of the first user equipment snapshot data record from the first network core).

In some embodiments, the step of determining, at the cloud connection manager, which of the user equipment snapshot data records received from the first network core correspond to a successful user equipment device migration from the first wireless network to the second wireless network further includes: determining a first user equipment snapshot data record for a first user equipment device does not correspond to a successful first user equipment device migration from the first wireless network to the second wireless network when a first confirmation message indicating a successful migration from the first wireless network to the second wireless network has been completed is not received at the cloud connection manager from the first user equipment device in the first period of time.

In some embodiments, the method further includes the additional steps of: receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network: receiving, at the connection manager, from each user equipment device which has successfully migrated from the first wireless network to the second wireless network a confirmation message indicating the completion of the successful migration of the user equipment device, said confirmation message including information (e.g., user equipment device identification information such as GUTI information and/or session identification information) from which corresponding user equipment snapshot data records can be identified: and identifying, at the cloud connection manager, which of the user equipment snapshot data records received from the first network core correspond to successful migrations of user equipment devices from the first wireless network to the second wireless network using information included in the received confirmation messages and a time when the confirmation message was received at the cloud connection manager.

In some embodiments, the confirmation messages are received, at the cloud connection manager, from the user equipment devices via the second wireless network.

In some embodiments, the confirmation messages are generated by connection manager applications executing on the user equipment devices which have been successfully migrated from the first wireless network to the second wireless network.

In various embodiments, the method further includes the steps of: receiving at the first network core the first modified OSS data: and performing automated network operations at the first core network based on the first modified OSS data.

In some embodiments, the automated network operations at the first core network include one or more of the following: (i) re-allocation of network resources (e.g., modifying spectrum allocations and/or transmit power allocations (e.g., increase transmit power) to one or more wireless base stations in the first wireless network based on actual session drops identified in the modified OSS data occurring in cells of the first wireless network, or (ii) modifying which types of communications sessions are to be migrated from the first wireless network to the second wireless network (e.g., changing the first wireless networks configuration to no longer off-load data sessions of a specific type (e.g., Youtube sessions from a specific IP address, real-time data sessions, or data sessions with a specific quality of service requirement)) from the first wireless network to the second wireless network.

In some embodiments, the session drops are a key performance indicator used for monitoring network performance of the first wireless network.

In some embodiments, the automated network operation (e.g., change in first wireless network configuration, change in transmission power level or change in spectrum assignments for one or more base stations in the first wireless network) is implemented to optimize performance of the first wireless network based on the modified session drop information included in the modified first OSS data.

In some embodiments, the first OSS data includes key performance indicators used for monitoring the performance of the first network.

In some embodiments, the modified first OSS data includes modified key performance indicators used for monitoring the performance of the first network. In some embodiments, the modified key performance indicators include one or more of the following number of sessions dropped by a base station within a time period, number of sessions dropped in each cell within the time period, number of session dropped in a cell sector within the given time period, data throughput for each cell within the given time period, data throughput for each cell sector within the given time period, far end server IP addresses with session drops above a first threshold, number of session drops by cell and session type over a period of time, number of session drops by cell sector and session type over a period of time.

In some embodiments, the step of identifying one or more false session drops in the first OSS data using the plurality of user equipment snapshot data records and the first plurality of session data records includes: comparing information contained in the user equipment snapshot data records which correspond to a successful UE migration to the session data records which include information on whether or not the session was dropped.

In some such embodiments, 12A. the information contained in the user equipment snapshot data records includes user equipment device identifier information (e.g., Cell Radio Network Temporary Identifier (C-RNTI), Globally Unique Temporary ID (GUTI), International Mobile Subscriber Identity (IMSI), International Mobile Equipment Identity (IMEIO information), time information (e.g., timestamp), location information (e.g., physical location and/or first wireless network cell or cell sector location), and session identifier information (e.g., Packet Data Network (PDN) ID information, Evolved Packet System Bearer Identifier (EPS bearer ID) information, Linked EPS Bearer ID (LBI) information, and Tunnel End Point Identifier (TEID) information).

The present invention is also applicable to apparatus and system embodiments wherein one or more devices implement the steps of the method embodiments. In some apparatus embodiments each of the correlator, cloud connection manager, wireless base stations, user equipment devices, network equipment devices and each of the other apparatus/devices/nodes/entities of the system include one or more processors and/or hardware circuitry, input/output interfaces including receivers and transmitters, and a memory. The memory including instructions when executed by one or more of the processors control the apparatus/device/node of the system to operate to perform the steps and/or functions of various method embodiments of the invention. The present invention is also applicable to and includes apparatus and systems such as for example, apparatus and systems that implement the steps and/or functions of the method embodiments. For example, a communication system in accordance with one embodiment of the present invention includes: a correlator and a cloud connection manager, the correlator including: memory, and a first processor, said first processor controlling the correlator to perform the following operations: receive from a cloud connection manager a plurality of user equipment snapshot data records corresponding to successful user equipment device migrations from a first wireless network to a second wireless network: receive from a first network core of a Hybrid Mobile Network Operator (HMNO) wireless system first Operations Support System (OSS) data, said first OSS data including a first plurality of session data records: identify one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicate the modified first OSS data to the first network core of the HMNO wireless system. In various embodiments, the user equipment snapshot data records include a timestamp, user equipment device identification information, session identification information, and location information.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates a HMNO system in accordance with an embodiment of the present invention.

FIG. 2 illustrates an exemplary system in accordance with an embodiment of the present invention.

FIG. 3 illustrates exemplary user equipment devices moving in and out of coverage of a native network.

FIG. 4 illustrates a signaling diagram which illustrates the steps and signaling of an exemplary method in accordance with an embodiment of the present invention.

FIG. 5 illustrates details of an exemplary Dual Subscriber Identity Module Dual Subscriber (DSDS) User Equipment (UE) device, e.g., a mobile device, cell phone, smartphone, wireless tablet, laptop, wireless notebook, in accordance with one embodiment of the present invention.

FIG. 6 illustrates details of an exemplary communications equipment device, e.g., network equipment device, correlator, cloud connection manager, UE snapshot manager, OSS device, MME, HSS in accordance with one embodiment of the present invention.

FIG. 7 illustrates an exemplary wireless base station in accordance with an embodiment of the present invention.

FIG. 8 illustrates an exemplary assembly of components for a user equipment device in accordance with an embodiment of the present invention.

FIG. 9 illustrates an exemplary assembly of components for a communications equipment device in accordance with an embodiment of the present invention.

FIG. 10 illustrates an exemplary assembly of components for a wireless base station in accordance with an embodiment of the present invention.

FIG. 11 illustrates an exemplary UE snapshot record.

FIG. 12 illustrates exemplary Operations Support System data.

FIG. 13A is the first part of a signaling diagram which illustrates the steps and signaling of an exemplary method in accordance with an embodiment of the present invention.

FIG. 13B is the second part of a signaling diagram which illustrates the steps and signaling of an exemplary method in accordance with an embodiment of the present invention.

FIG. 13C is the third part of a signaling diagram which illustrates the steps and signaling of an exemplary method in accordance with an embodiment of the present invention.

FIG. 13D is the fourth part of a signaling diagram which illustrates the steps and signaling of an exemplary method in accordance with an embodiment of the present invention.

FIG. 13 comprises FIG. 13A, FIG. 13B, FIG. 13C and FIG. 13D.

FIG. 14 illustrates an exemplary method in accordance with an embodiment of the present invention.

FIG. 15 illustrates an exemplary communications session data record in accordance with an embodiment of the present invention.

### DETAILED DESCRIPTION

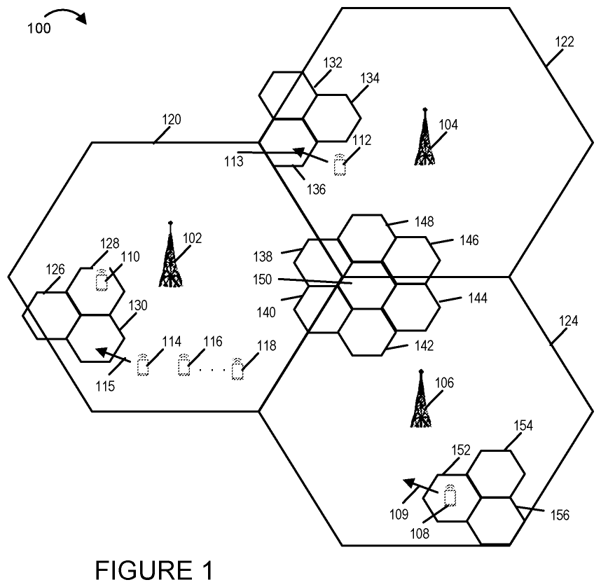

FIG. 1 illustrates a HMNO system/network 100 in accordance with an exemplary embodiment of the present invention. The MNO network (e.g., Verizon wireless network) is represented by the larger cells shown as hexagons (cells 120, 122, and 124) and the MSO network (e.g., Charter network) is represented by the small cell network shown with smaller hexagons (126, 128, 130, 132, 134, 136, 138, 140, 142, 144, 146, 150, 152, 154, 156) located primarily and in some embodiments exclusively within the footprint of the MNO network. The MSO small cell network's main purpose is for offloading traffic from the MNO network. A MVNO network (e.g., Charter MVNO network) is created using the MNO (Verizon network). The large cell network of the MNO and the small cell network of the MSO are operated by two different operators and in various instances are independent networks.

In the hybrid network shown in FIG. 1, there are a plurality of user equipment (UE) devices (UE devices 108, 110, 112, 114, 116, . . . , 118) which are dual Subscriber Identification Module (SIM) dual subscription mobile devices which move between and among the network cells of the two independent networks (i.e., the MNO network (e.g., Verizon network) and MSO network (e.g., Charter network). The MNO base station 102 provides wireless services to UE devices in the cell 120. The MNO base station 104 provides wireless services to UE devices in the cell 122. The MNO base station 106 provides wireless services to UE devices in the cell 124. The base stations for the cells of the MSO network are not shown. However, each of the MSO cells also has a base station which provides services to the UE devices in the respective cell. Arrow: 109 illustrates UE device 108 moving from MSO network cell 152 coverage into a location in which it only has coverage from MNO network cell 124. Note that UE device 108 is still within the coverage area of the MNO network cell 124. Arrow: 113 illustrates UE device 112 has moved into the MSO network coverage of MSO cell 136 from MNO network cell 122. Note that UE device 112 is still within the coverage area of the MNO network cell 122. Arrow 115 illustrates UE device 114 moving into MSO cell 130 coverage area. Note that UE device remains in MNO network 120 cell coverage as MSO cell 130 is encompassed by MNO network cell 120. Each of the dual SIM dual subscription user equipment devices including a first SIM module and first subscription allowing the UE to operate on a first network (e.g., a MNO network) and a second SIM module and second subscription allowing the UE to operate on a second network (e.g., a MSO network). Each of the plurality of UE devices' communication is managed by an agent such as a software agent, an application, or a component located/residing/executing on the user equipment device called a connection manager.

As a user equipment device moves from MNO coverage, e.g., Verizon coverage, to MSO coverage (e.g., Charter coverage), the UE device will barely communicate transfer data with the MNO network. The MNO network management and/or monitoring entities (e.g., Verizon Operations Support System (OSS)) might make a determination that the user equipment device is experiencing bad or poor performance, e.g., from a drop in the data throughput or what appears to be a dropped call/data session. Similarly, in the case of MSO network (e.g., Charter network) to MNO network (e.g., Verizon network) migration of user equipment devices' calls and/or data sessions, the MSO network management entities (e.g., Charter OSS) might make a determination that the user equipment devices in such migrations are experiencing bad or poor performance.

This apparent drop in performance leading to a determination of poor performance can be avoided by pre-emptively letting the network the user equipment device is primarily on or connected to that it could move out to the other network. For example, if a user equipment device is connected to and being serviced by the MNO large cell network and is to move to the small cell MSO network, the MNO network can be informed of the move. If the origin network from which the user equipment device moves from is informed in advance of the transfer to the destination network then the origin network can exclude or mark the user equipment device and/or its sessions/calls which are being transferred to the destination network. In this way, the origin network's network management entities (e.g., OSS and/or monitoring system) can take into account the transfer of the user equipment device and/or its call/data sessions to the destination network when generating its KPIs. In this way, the origin network's KPIs won't reflect a downgrade in performance, e.g., from including data resulting from false call drops or ghost calls which are actually just call/session transfers. In an exemplary embodiment of the invention, this is achieved by using the connection manager in the user equipment device and the Globally Unique Temporary IDs (GUTIs) of the respective networks which identify the user equipment device and the networks to which it is connected.

The connection manager in the user equipment device tracks the connectivity of the user equipment device, as well as monitors some packet level information such as for example session ID, packet sequence numbers, number of lost packets, which can be leveraged and/or utilized in determining and/or correcting network KPI information pertaining to the user equipment device and/or call and/or data sessions which are transferred between networks.

When a user equipment device is at a cell edge, the connection manager informs the networks of the possible move from one network, e.g., MNO network, to the other network, e.g., MSO network. However, this move may or may not happen. In either case, the two networks are ready for possible moves and get their internal systems ready for a possible move. Geo-fencing or predictive coverage is helpful in determining the possible change of networks. With geo-fencing, perimeters, also referred to as geofences, are created to surround the coverage area of the network. Geo-fences are created that trigger the connection manager to take actions when the geo-fence is crossed. The geo-fences being erected around the cell edges so that the UE will take actions when criteria are met e.g., as the cell edges of the network are approached and/or the geo-fence is crossed.

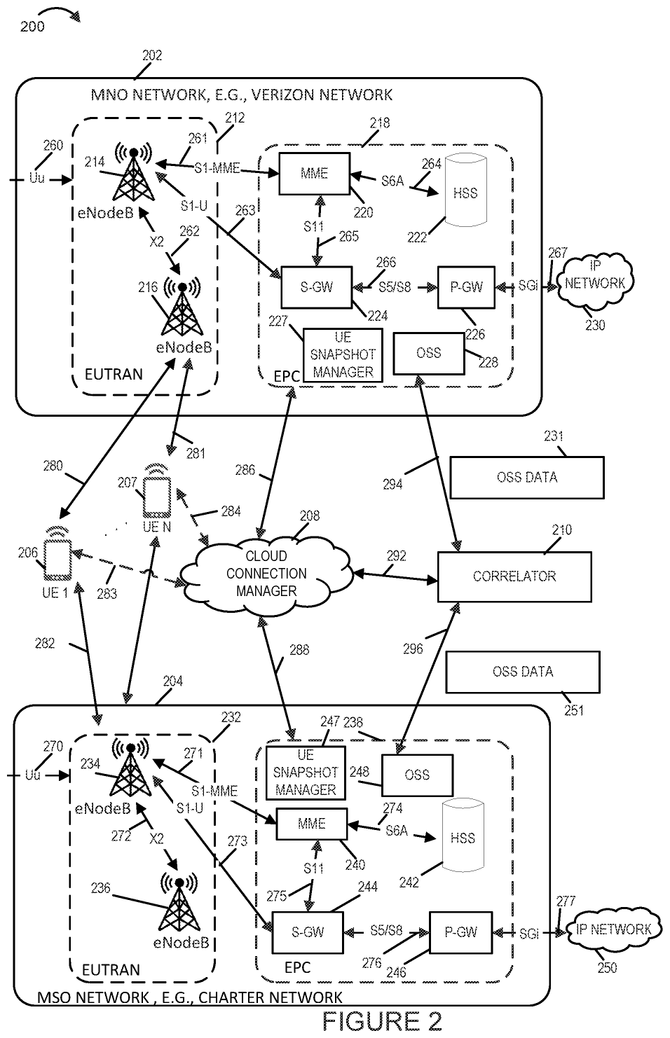

FIG. 2 illustrates an exemplary system 200 in accordance with an embodiment of the present invention. The exemplary system 200 includes a MNO wireless network 202, a MSO network 204, a plurality of user equipment devices UE 1 206, . . . , UEN 207 (N being an integer greater than 1), a cloud connection manager 208, a correlator 210, an IP network 230 and an IP network 250. The user equipment devices UE 1 206, . . . , UEN 207 are dual SIM dual subscriber user devices with subscription and SIM modules to operate on the MNO network 202 and MSO network 204. The UE devices UE 1 206, . . . , UE N 207 include wireless communications devices, e.g., mobile devices such as cell phones, smartphones, laptops, and tablets. Each of the UE devices UE 1 206, . . . , UE N 207 includes a connection manager that manages the communication for the UE on which it resides. The connection manager may be, an in various embodiments is, a software agent, software application, or a component (including hardware and/or software) located/residing/executing on the user equipment device. The connection manager located/residing/executing on each user equipment device is coupled and/or connected to a cloud connection manager 208.

The exemplary system 200 includes two wireless networks 202 and 204 which are independently operated. The network 202 and 204 are independent networks. The network 202 is a MNO network which in this example is operated by Verizon and is sometimes referred to as the Verizon network. The wireless network 204 is a MSO network which in this example is operated by Charter and is sometimes referred to as the Charter network. The two networks 202 and 204 together form a HMNO network. The MNO network being a Charter MVNO network wherein Verizon provides wireless services to Charter subscribers. Charter thus appearing as an MVNO with respect to the MNO network.

The MNO network 202 includes a wireless portion or network 212 which in this example is an Evolved-UMTS Terrestrial Radio Access Network (EUTRAN) network having a EUTRAN air interface and a core network 218 which in this example is an Evolved Packet Core. The wireless portion of the network 212 including a plurality of wireless base station (wireless base station 1 214 and wireless base station 2 216). The wireless base stations in this example are eNobeB base stations. While only two wireless base stations 214 and 216 are illustrated the wireless network 212 may have M base stations with M being integer greater than 2. The core network 218 is coupled/connected to the wireless network 212.

The core network 218 includes a variety of network equipment devices including a Mobile Mobility Entity (MME) 220, a Home Subscriber Server (HSS) 222, a Serving Gateway (S-GW) 224, a Packet Data Network Gateway (P-GW) 226, a UE snapshot manager 227, and an Operations Support Systems (OSS) 228 which are coupled/connected together via communications links so that they can exchange information and/or data. The OSS 228 performs network monitoring and management including the generation of Key Performance Indicators for the network for managing the network. The Key Performance indicators include call/session drops, data throughput, pack loss. The Key performance indicators are used to determine performance with various portions of the network including base station operation including performance of coverage at a sector and/or cell level and user equipment device experience (e.g., quality of service, packet loss, etc.) The P-GW 226 of the core network 218 is connected to the IP network 230 via an SGi interface over communication link 267.

The various elements of the MNO network are coupled together via communications links so that the elements can communicate and/or exchange data. Uu interface/link 260 represents the air interface the wireless base stations 214 and 216 have for communicating over the air with user equipment devices. The wireless base station 1 214 is coupled to wireless base station 2 216 via communications link 262 using an X2 interface. The wireless base station 234 is coupled to the MME 220 over communications link 261 using an S1-MME interface. The wireless base station 216 is also coupled to the MME 220 via a communications link using an S1-MME interface. The wireless base station 214 is coupled to S-GW 224 via communications link 263 using an S1-U interface. The wireless base station 216 is also coupled to the S-GW 224 via a communications link and using an S1-U interface. The MME 220 is coupled to HSS 222 via communications link 264 using an S6A interface. The MME 220 is coupled to the S-GW 224 via communications link 265 using an S11 interface. The S-GW 224 is coupled to the P-GW 226 via communications link 266 via an S5/S8 interface. The P-GW 226 is coupled to the IP network 230 via communications link 267 using an SGi interface. The OSS 228 is coupled/connected to correlator 210 via communications link 294 over which OSS data 231 for the MNO network 202 is exchanged. The cloud connection manager 208 is coupled to the core network 218 of the MNO network 202 via communications link 286. The UE 1 206 is coupled to the wireless base station 2 216 via communications link 280 using an Uu interface.

The MSO network 204 includes a wireless portion or network 232 which in this example is an Evolved-UMTS Terrestrial Radio Access Network (EUTRAN) network having a EUTRAN air interface and a core network 238 which in this example is an Evolved Packet Core. The wireless portion of the network 232 including a plurality of wireless base station (wireless base station 1 234 and wireless base station 2 236). The wireless base stations in this example are eNobeB base stations. While only two wireless base stations 234 and 236 are illustrated the wireless network 232 may have L base stations with L being integer greater than 2. The core network 238 is coupled/connected to the wireless network 232.

The core network 238 includes a variety of network equipment devices including a Mobile Mobility Entity (MME) 240, a Home Subscriber Server (HSS) 242, a Serving Gateway (S-GW) 244, a Packet Data Network Gateway (P-GW) 246, a UE snapshot manager 247, and an Operations Support Systems (OSS) 248 which are coupled/connected together via communications links so that they can exchange information and/or data. The OSS 248 performs network monitoring and management including the generation of Key Performance Indicators for the network for managing the network. The Key Performance indicators include call/session drops, data throughput, pack loss. The Key performance indicators are used to determine performance with various portions of the network including base station operation including performance of coverage at a sector and/or cell level and user equipment device experience (e.g., quality of service, packet loss, etc.) The P-GW 246 of the core network 238 is connected to the IP network 250 via an SGi interface over communication link 277.

The various elements of the MSO network are coupled together via communications links so that the elements can communicate and/or exchange data. Uu interface/link 270 represents the air interface the wireless base stations 234 and 236 have for communicating over the air with user equipment devices. The wireless base station 1 234 is coupled to wireless base station 2 236 via communications link 272 using an X2 interface. The wireless base station 234 is coupled to the MME 240 over communications link 271 using an S1-MME interface. The wireless base station 236 is also coupled to the MME 240 via a communications link using an S1-MME interface. The wireless base station 234 is coupled to S-GW 244 via communications link 273 using an S1-U interface. The wireless base station 236 is also coupled to the S-GW 244 via a communications link and using an S1-U interface. The MME 240 is coupled to HSS 242 via communications link 274 using an S6A interface. The MME 240 is coupled to the S-GW 244 via communications link 275 using an S11 interface. The S-GW 244 is coupled to the P-GW 246 via communications link 276 via an S5/S8 interface. The P-GW 246 is coupled to the IP network 250 via communications link 277 using an SGi interface. The OSS 248 is coupled/connected to correlator 210 via communications link 296 over which OSS data 251 for the MSO network 204 is exchanged. The cloud connection manager 208 is coupled to the core network 238 of the MSO network via communications link 286. The UE 1 206 is coupled to the wireless base station 1 234 via communications link 282 using a Uu interface.

At least several of the plurality of UE devices (UE 1 206, . . . , UE N 207) in this example are within the coverage area of the wireless base station 216 of the MNO network. At least several of the plurality of UE devices (UE 1 206, . . . , UE N 207) in this example are within the coverage area of the wireless base station 234 of the MSO network.

The cloud connection manager 208 is located in a cloud (e.g., cloud system or environment) and operates in connection and/or conjunction with the connection managers on each of the plurality of user equipment devices to coordinate and/or manage the communication paths for the user equipment devices as UE devices and/or communications sessions of the UE devices (e.g., call sessions, data sessions) are transferred between the MNO network 202 and the MSO network 204. The cloud connection manager 208 is coupled to the core network 218 of the MNO network 202 via communications link 286. The cloud connection manager 208 is coupled to the core network 238 of MSO network 204 via communications link 288.

The UE devices 1 206, . . . , UE N 207 are coupled to the cloud connection manager 208. Logic communications links 283, . . . , 284 represent the connection between the user equipment devices 1 206, . . . , UE N 207 respectively. The physical communication path between the UE devices and the cloud connection manager is via the wireless base stations in the MSO network and/or MNO network to which the UE devices are connected.

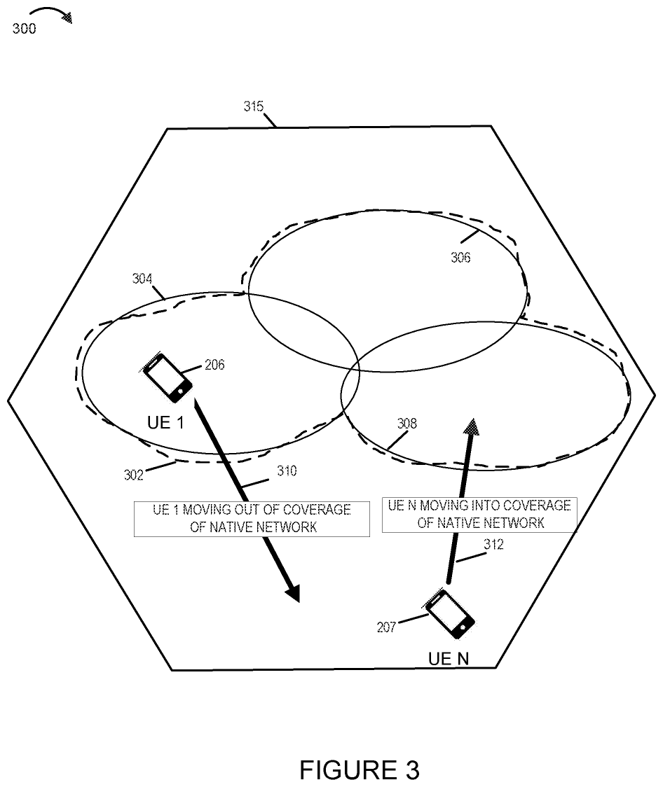

Diagram 300 in FIG. 3 illustrates geo-fencing with UE 1 206 from system 200 moving out of coverage of the native network (i.e., the MSO network 204, e.g., the Charter network) and UE N moving into coverage of the native network (i.e., the MSO 204, e.g., the Charter network.

The ellipses 304, 306 and 308 of diagram 300 illustrate MSO network 204 cells in which MSO base stations provide wireless services. The MSO network in this example is referred to as the native network. The hexagon 315 illustrates a cell from the MNO network 202 and its coverage includes the three MSO network cells 304, 306 and 308 coverage area. The dashed line 302 represents a geo-fence around the MSO network's coverage area which is the outer perimeter of the combined coverage area of the MSO network cells 304, 306, and 307.

The UE 1 206 being connected to and serviced by the wireless base station 234 in the MSO network 204 (e.g., the Charter network). The MNO network has coverage throughout the entire area enclosed by the cell 315 for example coverage being provided by base station 216. Arrow 310 illustrates UE 1 206 moving out of the coverage of native network (i.e., MSO network 204). As the UE 1 device 206 approaches the geo-fence 302, the connection manager residing/located/executing on the UE 1 device 206 determines based on criteria including the UE 1 device's location and in some instances direction of the UE 1 device 206 to take measurements and provide information on the state of UE 1 device 206. As the UE 1 device 206 moves out of coverage of the native network, the UE 1 206 and/or one or more of its active calls/sessions is transferred to the MNO network (i.e., the MNO network 202, e.g., the Verizon network) where wireless services are provided by the MNO network 202.

Consider UE 1 device 206 moving along a street and is about to exit or go outside of the MSO network's 204 (e.g., Charter network's) coverage area as shown by arrow 310. That is UE 1 device 206 is about to go outside the coverage area of the MSO network by exiting cell 304's coverage area. Since the MSO network 204 is tracking the UE 1 device 206, the MSO network 204 can pre-emptively notify and/or command the UE 1 device's 206 connection manager to start active profile tracking as the UE 1 device 206 is likely to lose MSO network coverage at any moment.

Since the UE 1 device 206 will disappear from MSO network 204 (e.g., Charter's network) when it exits the MSO network 204 coverage area, the MSO network 204 will assume that there has been a call drop and/or a performance degradation in the MSO network 204 once UE 1 device 206 disappears from its network.

The connection manager on the user equipment device 1 206 is triggered by these events and sends/transmits this information back to one or more elements in the MSO's (e.g., Charter's) core network. The MSO core network is aware of the switch from the MSO network 204 to an MVNO network (i.e., the MNO network 202 (e.g., Verizon's network)). However the performance monitoring system for the MSO network 204, e.g., the performance monitoring system which is part of the OSS 248, is unaware that some of these events are actually not undesirable, i.e., the user equipment device 1 206 has not lost service but is being serviced by the MNO network 202. The MNO network (e.g., Verizon network) providing services on behalf of the operator of the MSO network (e.g., Charter network).

One of the important metrics of concern for this case, is the Key Performance indicator tracking connection drops. This has two major cases. The first is the ping-pong case when the user equipment device (e.g., UE 1 206) is near the edge of the network but returns to the network of origin (e.g., the UE 1 206 goes to the MSO network edge but is not transferred to the MNO network but instead goes back to the MSO network for example by changing direction). The second case is when the user equipment device does not return to the network of origin. This is shown in FIG. 3 where the UE 1 206 moves out of coverage of the MSO network 204 and is transferred to the MNO network 202. In the first case, the MSO network has to know the potential cases of ping-pongs when to expect them and when they are actually triggered.

Geo-fencing for the coverage area of the MSO network 204 (e.g., the Charter network) along with using the location of the UE with respect to the Geo-fence can be used to identify such cases. In some embodiments, the velocity of the user equipment device in addition to the user equipment device's location with respect to the geo-fence is used in identifying instances when the UE is about to leave a network. This is shown in FIG. 3 where UE 1 206 is moving out of MSO network 204 with the location of the UE 1 with respect to the geo-fence 302 being used to determine such cases. The switch to the pre-emptive active profile tracking mode of operation where the connection manager sends pre-emptive information about the UE's current state (e.g., location information, signal strength and/or quality information, context information for active sessions, etc.) to the network occurs when the UE device is near the geo-fence (e.g., within a first threshold distance of the geo-fence). The connection manager however sends the trigger/command to switch from the MSO network 204 to the MNO network 202 when one or more thresholds are crossed with respect to the signal strength and quality of the MSO network 204 (e.g., Reference Signal Received Power and Reference Signal Received Quality) as compared to the MNO network 202.

When a UE is near the edge of the network as represented by the geo-fence, the UE provides information to the MSO network which will generate a snapshot of the current state and/or conditions of the UE (e.g., location information, signal strength and quality measurements, context information for active sessions, etc.). The snapshot information will include a timestamp of when the snapshot was taken. In some embodiments, the UE takes the snapshot and provides it the MSO network core. In some embodiments, the UE provides information e.g., UE location information, signal measurements, UE identification information, UE context information for active calls/sessions and provides this information to an entity in the MSO network, e.g., snapshot management device which generates the UE snapshot based on UE provided information. The MSO network and/or the cloud connection manager will retain this information for a period of time along with the two Globally Unique Temporary IDs (GUTIs) associated with the UE to determine if the snapshot information is for a ping-pong case or an actual transfer from the MSO network to the MNO network. The snapshot is generated or taken when a set of criteria is met. For example, the criteria in some embodiments is that UE is at the border of the MSO network's coverage (e.g., based on the UE location with respect to the geo-fence). In some embodiments, the criteria is the UE is near the border of the MSO network's coverage and is about to depart the MSO's network and be transferred to the MNO's network (e.g., the criteria being the location and velocity of the UE with respect to the geo-fence such as within two feet of geo-fence and moving in a direction to cross the geo-fence and leave the coverage of the MSO network.)

In various embodiments, user equipment device's movements are tracked by the network, and the network element(s), e.g., snapshot management device, and/or user equipment device will take or generate a snapshot of UE information when certain criteria are met such as an indication that the UE is about to depart the MSO network. The snapshot will include a timestamp. This criteria can be based on RSRP, RSRQ and other wireless parameters relating to signal degradation and/or when a user equipment device is experiencing poor quality. In some embodiments, the criteria is based on location tracking of the UE with respect to the network coverage boundaries for example location and/or direction of movement with respect to the geo-fence. In various embodiments, a criteria for determining a UE snapshot is to be taken includes a signal quality component as well as a network coverage based component (e.g., UE device location component). Multiple snapshots are possible. In some embodiments, there is a set of criteria wherein a UE snapshot is taken each time one of the members of the set of criteria is met. The set of criteria may, and in some embodiments does, include: (i) location of UE with respect to geo-fence, (ii) location of UE and direction of travel of the UE with respect to the geo-fence (e.g., travelling toward the geo-fence), signal power of a reference signal received from the MSO network by the UE (e.g., a received reference signal power being at or below a first threshold value), signal quality of a reference signal received from the MSO network (e.g., a received reference signal being at or below a received reference signal quality value).

The MME element of the network (e.g., MME 240 of the MSO network 204 in this example) is responsible for mobility and connectivity related assignments for the UEs. The HSS element of the network (e.g., HSS 242 of the MSO network 204 in this example) is used to store UE profiles, registrations and related information. In some embodiments, a network element such as for example a UE snapshot manager 247 generates UE snapshots using connection and connectivity information from the MME (e.g., MME 240) and UE profile information from the HSS (e.g., 242). For example, the UE snapshot manager 247 may and in some embodiments does use MME and HSS information in generating UE snapshots. The UE snapshots will be saved in memory or a storage device and sent over/transmitted to the cloud connection manager 208. The cloud connection manager 208 will obtain this information for all the UEs being serviced by the MSO network. This information can be at a UE level or in some embodiments at a group level, e.g., a group of UEs in a particular cell or sector of the MSO network.

The cloud connection manager 208 will send the snapshot information to a correlator 210 which is a data processing entity/device such are for example a database system. The correlator 210 is sometimes located with or is part of the cloud connection manager 208. In some embodiments, the correlator 210 may be located in or be part of one of the core networks, e.g., MSO core network. 238. The Correlator 210 also receives MSO network OSS data 251 from the MSO network 204 and MNO OSS data 231 from the MNO network 202. The MSO OSS data 241 includes call/session drop information determined by the monitoring system of the OSS 248. In some embodiments, network monitoring system data/information instead of or in addition to OSS data 251 is provided to the Correlator 210 (e.g., when a network monitoring system separate from the network OSS is used to monitor a network and determine network metrics and/or KPIs for the network).

The Correlator 210 will process the UE snapshot information/data received from the Cloud Connection Manager 208 and determine the number of call/session drops that initiated by the connection manager. These drops are the false/ghost call/session drops as they correspond to calls/sessions which were transferred to the MNO network 202 when the UE moved outside the coverage area of the MSO network 204. The MSO network 204 does not know the cause of these call/session drops. These false/ghost calls/sessions are then identified and removed from the MSO network OSS data 251 by the Correlator 210 as they are not actual call/session drops. When these false/ghost call/session drops are removed from the MSO network OSS data, the modified MSO OSS data represents the true and/or a more accurate state of the MSO network, i.e., the MSO OSS data no longer includes false/ghost call/session drops triggered by the connection manager.

In some embodiments, the UE snapshot data will be transferred to the Cloud Connection Manager on a period basis, e.g., every minute. There will be two types of UE snapshot data. The first being ping-pong data and the second being actual UE call/session transfer data. The ping-pong UE snapshot data is provided to avoid recording a UE snapshot as a transfer when the UE is in a transition state. The communication of the UE snapshot data will be based on Application Programming Interfaces (APIs) in some embodiments. In some embodiments, the communication of the UE snapshot data is provided using a HTTP/HTTPS push and pull model. A push and pull model can be used to ensure that information is only exchanged when needed as opposed to an always on model.

In another exemplary embodiment explained in connection with system 200 of FIG. 2, the MSO network core 238 will continuously observe UE devices which are connected to MSO network 204 and for which the MSO network is providing services. The MSO network core 238 will receives UE location and signal measurements (e.g., RSRP and RSRQ) information from the UE devices connected to and being serviced by the base stations of the MSO network 204, e.g., base stations 234 and 236. In various embodiments, the UE snapshot manager 247 is the element or entity (e.g., function, node, device) in the MSO network core 238 which manages the oversight of the UE snapshots including the generation and transmission of UE snapshot records/data. In some embodiments, the UE snapshot manager 247 performs or instructs other elements in the MSO network core 238 to generate and/or transmit UE snapshot records and/or data to cloud connection manager 208.

The MSO network core 238 (e.g., via the UE snapshot manager 248) based on the location and signal measurement information received from a UE determines whether or not a UE snapshot is to be generated for the UE based on whether a first criteria or set of criteria is met. The criteria is sometimes referred to a trigger or trigger in that when the criteria is met it triggers the generation of a UE snapshot.

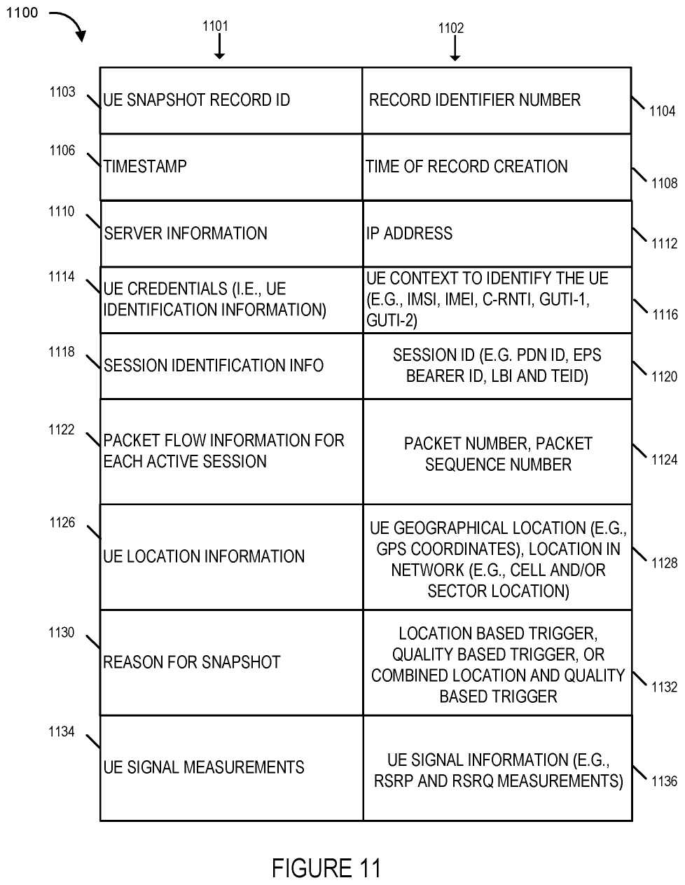

When the UE snapshot criteria is met, the MSO network core 238 (e.g., UE snapshot management device of the MSO network core 238) generates or takes a snapshot of the state/condition of the UE. The UE snapshot includes: (1) a timestamp for when the snapshot was generated, (2) identification information for identifying the UE to which the snapshot corresponds (e.g., GUTI-1 and GUTI-2 identifiers for the two dual SIM cards of the UE, UE credentials (e.g., UE context information such as IMSI, IMEI, C-RNTI information), (3) session IDs to identify active sessions, (4) packet information regarding packets for each session identified (e.g., packet number, packet sequence number), (5) reason for the snapshot (e.g., location based trigger or signal quality based trigger), (6) location of UE (e.g., cell level location such as cell sector location within the system, physical location (e.g., from GPS), (7) signal quality based trigger information such as RSRP and RSRQ for the MSO network, and (8) server information: IP addresses for servers providing data to the UE device. FIG. 11 illustrates an exemplary UE snapshot record 1100.

The MSO network core 238 transmits the UE snapshots to the cloud connection manager 208. The cloud connection manager 208 receives these UE snapshots transmitted from the MSO network core 238. The received UE snapshots are saved temporarily by the cloud connection manager 208, e.g., in memory or storage device such as a database. The reason to store these UE snapshots is two fold. First, to make sure that ping-pong cases are eliminated by waiting for a period of time, e.g., a first period of time. Second, to accumulate data, e.g., multiple UE snapshots before forwarding or transmitting them to the correlator 210 so that a plurality of UE snapshots are sent at one time, e.g., as a batch or for batch processing. The period of time to wait for confirmation from a UE of a successful migration (e.g., a first period of time) is typically different than the period of time (e.g., a second period of time) to accumulate multiple UE snapshots corresponding to successful transfers/migrations before transmission/forwarding from the cloud connection manager 208 to the correlator 210. In the case that the UE snapshots corresponding to successful transfers/migrations to MNO network, the UE snapshots may be, and in some embodiments are, accumulated for multiple UEs over the course of a second time period for example 10-15 and then forwarded/transmitted to the correlator 210. In some embodiments, once the cloud connection manager 208 determines that a UE snapshot corresponds to a successful migration, it does not wait to accumulate additional UE snapshots corresponding to successful migrations but sends the UE snapshot data to the correlator 210.

As previously explained after storing a UE snapshot, the cloud connection manager 208 waits for a fixed period of time for the UE to which the UE snapshot corresponds to provide more information. For example, if the UE has transferred over to the MNO network 202 successfully, the UE informs the cloud connection manager 208, e.g., via the MNO network 202 to which it transferred.

Ping-pong transfers/transitions are eliminated by the cloud connection manager 208, comparing multiple snapshots or when there is no successful transfer confirmation message received from the connection manager in the UE within the fixed period of time.

There are two possibilities. If the connection manager on the UE informs the cloud connection manager 208 of the successful migration, the UE snapshot will be recorded and it will not be considered as a drop. GUTIs of the UE and UE context information as well as UE identifying information in the UE snapshot can then be used by the correlator 210 to correlate the UE snapshot with the MSO OSS data 221 for the false/ghost call/session drop recorded when the transfer from the MSO network 204 to the MNO network 202 occurred. In the case of a ping-pong, the UE returns to MSO network within a few milliseconds. In that case, there is no confirmation of a successful migration from the MSO network 204 to the MNO network 202 sent from the connection manager on the UE to the cloud connection manager. So, the snapshot represents a dropped call/session or return to the network. In the former case, the MSO network OSS 248 will record it as a dropped call/session in the OSS data. In the latter as the call/session didn't transfer s it will not be recorded in the MSO OSS data a dropped call/session.

The Operations and Support System (OSS) of a network core (e.g., the MNO network OSS 228 and MSO network OSS 248) are systems that gather all operations related data for their respective networks. This data includes the network side view of performance data such as call/session drops, data throughput, etc. The MSO network OSS 248 collects/gathers operations related data for the MSO network 204. The MNO network OSS 228 collects/gathers operations related data for the MNO network 204. In various embodiments, the MSO network OSS data collected includes call/session data records which include information on calls/sessions including call/session drops by MSO network. However, the MSO network OSS is unaware of when UEs and/or UE calls/sessions have been successfully transferred to the MNO network and the MSO network OSS considers these calls/sessions as dropped calls/sessions indicating poor network performance. The Key Performance Indicator for MSO network dropped calls/sessions will be higher than the actual number of dropped calls/sessions providing an incorrect indication that the MSO network is underperforming, when in fact the, the UEs and/or UE calls/sessions have been successfully transferred over to the MNO's network. The same is true for MNO network OSS data collected on UE and/or UE call/session transfers from the MNO network to the MSO network.

The address this problem, the MSO OSS 248 sends OSS data 251, e.g., call/session data records and/or event data records, to the correlator 210. The correlator 210 will take the MSO OSS data 251 which it receives from the MSO OSS 248 and correlate it with the UE snapshot data received from the cloud connection manager 208. The MSO OSS data 251 includes location information, e.g., network cell and/or sector location information as well as time stamp information.

The correlator 210 will for the same time frame, take the UE snapshots and determine if there is a match to the MSO OSS data call/session drop. If there is a match, the correlator 210 will mark the MSO OSS data record as a successful transfer and remove it from the call/session drop records/statistics. The removal of the false call/session drops which were actually transferred/migrated will provide an accurate KPI with respect to call/session drops and data throughput drops as the modified OSS data will now reflect actual call/session drops and will not include false/ghost call/session drops which were actually successful transfers.

The correlator 210 will transmit the modified OSS data back to the MSO OSS 248. The MSO OSS 248 will then utilize the modified OSS data to identify portions of the MSO network 204 with actual call/session drops above a first performance threshold and modify the MSO network 204's configuration to reduce the call/session drops or data throughput drops in that portion of the network, e.g., by increasing transmit power at base stations in those portions of the network, modifying spectrum allocations to base stations, modifying data sessions the MSO OSS 204 will support as opposed, changing, e.g., lowering the quality threshold levels for transferring/migrating UEs and/or UE calls/session to the MNO 202 network in the location, e.g., sector with number or drop calls above a certain threshold.

The overall network is a Hybrid Mobile Network Operator network with MSO network be an actual network operated by a first operator (e.g., Charter) and the MNO network 204 being owned an operated by a second operator (e.g., Verizon) on behalf of first operator (e.g., Charter) as a first operator MVNO network (e.g., Charter MVNO network). Each of the UEs being dual subscriber dual subscription user equipment devices allowing them to access both the MNO network 202 and the MSO network 204 simultaneously. As a result, transferring the UE or the UE call/session is not a dropped call/session in the Hybrid Mobile Network Operator system and should not appear as such in the KPIs for the MSO network as it will distort the MSO's network performance. The methods and apparatus described above allow for accurate determination and use of KPIs (e.g., UE drops, UE call/session drops, data throughput drops) by eliminating false/ghost drops of UEs and/or UE calls/sessions and the modification of related KPIs dependent, based on, or related to false/ghost drops of UE calls/sessions such as data throughput.

While the methods and apparatus above have been described with respect to generating and using accurate KPIs for the MSO network 204 the methods can also be used for generating and using accurate KPIs for the MNO network 202 (i.e., MVNO network) using the corresponding apparatus in the MNO network 202. For example, in situations when the UE N 207 of system 200 of FIG. 2 moves into the coverage of the MSO network 204 as shown in FIG. 3 with one or more of its calls/session being transferred to the MSO network 204. In such cases, the MNO network 204 OSS data 231 will include false/ghost UE drops and/or UE false/ghost call/session drops which are actually transfers/migrations to the MSO network 202 by the UE's connection manager. UE snapshots can be generated by the MNO network core 218 (e.g., by UE snapshot manager 227) as a UE, e.g., UEN 207, which is being serviced by the base station 216 in the MNO network 202 approaches the MSO network geo-fence (e.g., trigger event for a UE snapshot can be based on location with respect to the geo-fence or quality as previously explained). The MNO network core 218 would then transmit the UE snapshot to the cloud connection manager 208. The cloud connection manager 208 would wait a period of time for confirmation of a successful transfer/migration from the UE corresponding to the UE snapshot, e.g., UE N 207. If a confirmation was received, e.g., from the connection manager in the UE, e.g., UE N 207 via the MSO network, the UE snapshot would be forwarded/transmitted to the correlator 210. Otherwise, if no confirmation of a successful migration/transfer to the MSO network was received within the time period the UE snapshot would be deleted. The cloud connection manager 208 could accumulate a plurality of UE snapshots of successful migrations/transfers to the MSO network 204 prior to transferring the UE snapshot data to the correlator 210. The correlator 210 in response to receiving the UE snapshots for the successful migrations/transfers from MNO network 202 to the MSO network 204 would compare the UE snapshot data to the MNO OSS data 231 received from the MNO network OSS 228 and mark and then remove any UE drops and/or UE call/session drops which match the UE snapshots of successfully migrations/transfers to the MSO network as these drops are false/ghost drops. The modified MNO OSS data and/or KPIs is then transmitted back to the MNO OSS 228 which uses the accurate KPIs (UE call/session drops and/or data throughput drops) to take a mitigation action when a threshold level of UE drops, UE call/session drops, and/or data throughput drops is exceeded. A mitigation action being for example, changing spectrum allocations and/or power allocations to base stations to reduce the actual drops or data throughput drops detected.

In some embodiments, the correlator 210 receives and uses OSS data from both the network of origin and the destination network with respect to UE call/session transfers/migrations. In such embodiments, the correlator 210 can also identify the OSS data from both networks corresponding to a UE call/session transfer and utilize this information to determine KPI metrics for the call/session such as packet loss based on session and/or packet level information provided in UE snapshot data (e.g., packet number or packet sequence number).

The signaling diagram/method 400 illustrates the generation, message flow and usage of UE snapshot information by, and among, a dual SIIM dual subscriber user equipment device 404, a network 1 core 402, a cloud connection manager 408 and a correlator 410 in accordance with an exemplary embodiment of the present invention.

The signaling diagram/method 400 may be, and in some embodiments is, implemented using exemplary system 200 of FIG. 2. In one such exemplary implementation, the network 1 core 402 is the MSO network core 238 of the MSO network of system 200. The UE 404 is UE 1 206 of system 200 which is user is Dual SIM Dual Subscriber (DSDS) user equipment device. The cloud connection manager 408 is cloud connection manager 208 of the system 200. The correlator is 410 is the correlator 208 of system 200. However, it should be understood that the method 400 is not limited to the exemplary system 200 and may be, and is used, on other systems and system configurations. The signaling diagram/method 400 illustrates the generation, message flow and usage of UE snapshot information in accordance with an exemplary embodiment of the present invention.

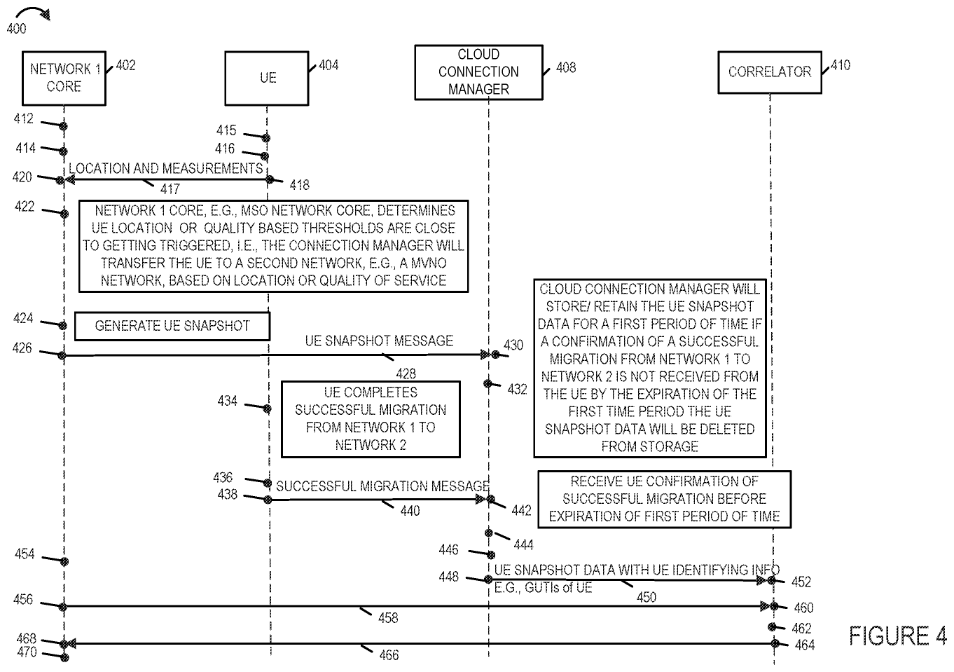

The method 400 starts in start step 412 shown on FIG. 4. Operation proceeds from start step 412 and proceeds in parallel to steps 414 and 415.

In step 414, the network 1 core 402 is providing wireless service to the UE 404 for one or more sessions, e.g., call and/or data sessions. The UE 404 is connected to a first wireless network of the network 1 core 402, e.g., Charter network. Operation proceeds from step 414 to step 420.

In step 415, the UE 404 performs signal measurements, e.g., RSRP and RSRQ signal measurements with respect to reference signals it is receiving from different base stations in different wireless networks. The different networks including the first wireless network (e.g., Charter network) and a second wireless network (e.g., Verizon network). The different networks being networks for which the DSDS UE 404 is provisioned. In step 404, the UE also determines location information for the position of the UE device e.g., from a GPS receiver on the UE device. Operation proceeds from step 415 to step 416.

In step 416, UE 404 generates message 417 which includes the measured signal information and determined UE location information. In some embodiments, the message 421 also includes UE identity information (e.g., GUTI 1, GUTI 2, IMSI), session IDs, UE context information for active sessions, and/or packet level information (e.g., packet sequence number for each session), and a timestamp. Operation proceeds from step 416 to step 418.

In step 418, UE 404 transmits message 417 to the network 1 core 402 via a base station of the network 1. For example, when UE 404 is UE 1 206 of system 200, UE 1 206 transmits message 417 to the UE snapshot manager 247 of the core network 238 of MSO network 204. The message 417 being transmitted from UE 1 206 to the UE snapshot manager 247 via wireless communications link 282 and wireless base station 234. In some embodiments, the UE snapshot manager 247 is implemented as function or component of the OSS 248. Operation proceeds from step 416 to step 420.

In step 420, the network 1 core 402 (e.g., MSO network core 238 UE snapshot manager 247) receives and processes message 417 from UE 404. Operation proceeds from step 420 to step 422.

In step 422, the network 1 core 402 (e.g., MSO network core 238 UE snapshot manager 247) determines that UE location and/or quality based thresholds are close to getting triggered, i.e., the connection manager on the UE will transfer the UE to a second network (e.g., a Charter MVNO network implemented on Verizon MNO) based on the UE's location or quality of service measurements reported by the UE in the message 417. Operation proceeds from step 422 to step 424.

In step 424, the network 1 core 402 (e.g., MSO network core 238 UE snapshot manager 247) generates a UE snapshot record for the UE 404 including the following information (timestamp of when the snapshot was created, server information (e.g., IP address), UE credentials (e.g., UE context to identify the UE-data such as IMSI, IMEI, C-RNTI that can be used to determine the UE 404's identity, session ID(s) (e.g., PDN ID, EPS bearer ID, LBI and TEID to identify active sessions), packet flow information (e.g., packet number, packet sequence), reason for snapshot (e.g., location based trigger or signal quality based trigger), UE location information (e.g., cell and/or sector level location for the wireless network 1 (e.g., MSO network), physical location (e.g., GPS location)). The UE snapshot is generated based on information contained in the message 417 (e.g., UE location information, signal measurements, UE context information). The UE snapshot is also generated based on information in the network 1 core (e.g., connectivity information for the UE 404 maintained in the MME 240 and UE 404 profile information contained in the HSS 242). Operation proceeds from step 242 to step 426.

In step 426, the network 1 core 402 transmits message 428 which includes the generated UE snapshot record and/or information to cloud connection manager 408. The cloud connection manager 408 is various embodiments is located in a cloud system or environment separate from the network 1 core 402. Operation proceeds from 426 to step 430.

In step 430, the cloud connection manager 408 receives and processes the UE snapshot message 428. Operation proceeds from step 430 to step 432.

In step 432, the cloud connection manager 408 stores/retains the UE snapshot data received in the UE snapshot message 430 in memory or a storage device for a first period of time. If the a confirmation of a successful migration from network 1 to a network 2 is not received from the UE 404 by the expiration of the first period of time the UE snapshot data will be deleted from storage. In this example, a successful migration message 440 is received from the UE by the connection manager 408 as discussed below. Operation proceeds from step 430 to step 434.

In step 434, the UE 404 completes the successful migration from network 1 to network 2 (e.g., MNO network 202, e.g., MNO Verizon network operated as MVNO network for Charter). Operation proceeds from step 434 to step 436.

In step 436 UE 404 generates successful migration message 440 which indicates the successful migration of the UE and/or one or more UE call/data session from the network 1 to the network 2. This message 440 is generated by the connection manager located/residing in/executing on the UE 404. The message 440 includes information identifying the UE (e.g., GUTIs, IMSI, UE credentials from which the UE 404 can be identified) as well as session ID information for identifying the calls/sessions which have been successfully transferred/migrated to network 2 from network 1, and a timestamp. Operation proceeds from step 436 to step 438.

In step 438, the successful migration confirmation message 440 is transmitted from UE 404 to the cloud connection manager 408. For example, when the UE 404 is UE 1 206 of system 200, network 1 is MSO network 204, network 2 is MNO network 202, cloud connection manager 408 is cloud connection manager 202, the UE 1 206 transmits the message 440 to the cloud connection manager 404 via MNO network 202 wireless base station 216 to MNO network core 208 to cloud connection manager 208 via communications link 286. In this example, the UE 1 206 has transferred/migrated to MNO network 202 from the MSO network 204 and no longer has a wireless connection to the wireless base station 234 as it is out of the coverage area of the MSO network 204. In some embodiments, the information indicating a successful transfer/migration is communicated from the UE 404 to the cloud connection manager 408 using a plurality of messages generated by network elements on the path between UE 404 and the cloud connection manager 408. Operation proceeds from step 438 to step 442.

In step 442, the cloud connection manager 408 receives the message 440 from UE 404 with information confirming the successful transfer/migration of the UE 404 and/or UE calls/sessions from network 1 to network 2 with information to identify the UE and calls/sessions migrated and a timestamp. The UE confirmation message 440 being received before the expiration of the first period time. Operation proceeds from step 442 to step 444.

In step 444, the cloud connection manager 408 identifies and marks the UE snapshot saved in storage using the information, e.g., UE identification information, e.g., GUTI information, received in the confirmation message 440. If multiple UE snapshots were taken because multiple trigger events occurred before the transfer/migration to the network 2, the cloud connection manager 408 identifies and marks the UE snapshot with most recent timestamp and deletes the other UE snapshots for UE 404. Operation proceeds from step 444 to step 446.

In step 446, the cloud connection manager 408 generates message 450 which includes UE snapshot data for the identified UE snapshot which corresponds to the UE 404 successful migration/transfer to network 2. In some embodiments, step 446 occurs after a plurality of UE snapshots for different UEs have been marked as being for successful transfers/migrations, e.g., from network 1 to network 2. The message 450 includes the UE snapshot data with UE identifying information, e.g., GUIs of UE 404. Operation proceeds from step 446 to step 448.

In step 448, the cloud connection manager 408 transmits the UE snapshot data with UE identifying information (e.g., GUTIs of UE 404) message 450 to the correlator 410 (e.g., correlator 210 of system 200). Operation proceeds from step 448 to step 452.

In step 452, the correlator 410 received the message 450 with UE snapshot data for UE 404 which corresponds to a successful transfer/migration of the UE 404 or a UE 404 call/session from network 1 to network 2. Operation proceeds from step 452 to step 454.

In step 454, the network 1 core 402 (e.g., MSO network core 238 OSS 248) generates OSS data 251 which includes OSS data records of UE call/session drops including the UE 404 session drop when the UE 404 transferred/migrated from network 1 to network 2. Operation proceeds from step 454 to step 456.

In step 456, the network 1 core 402 (e.g., MSO OSS 248) transmits/communicates the network 1 OSS data 251 in message 458 to the correlator 410. Operation proceeds from step 456 to step 460.

In step 460, the correlator 410 receives the message 458 and extracts the network 1 OSS data 251 from the message 458. Operation proceeds from step 460 to step 462.

In step 462, the correlator 410 uses the UE snapshot information received in step 452 to identify the network 1 OSS data record(s) received from the network 1 core (e.g., MSO OSS 238) in step 460 which correspond to the ghost/false dropped UE and/or ghost/false dropped UE call/session corresponding to the UE 404 successful transfer/migration from network 1 to network 2. Upon identifying the ghost/false dropped UE and/or ghost/false dropped UE call/session corresponding to the UE 404 successful transfer/migration from network 1 to network 2 and removes this record and/or information from the network 1 OSS data, e.g., MSO OSS data 251 received from OSS 248 in system 200. In various embodiments, the correlator corrects KPI information such as session drop and/or data throughput drops corresponding to UE transfers/migrations such as the UE 404 transfer/migration to which the UE 404 snapshot corresponds. The identification is made using the timestamp, UE identifying information (e.g., GUTI value for UE 404), and session identifiers. In some embodiments, the identification is also made using the location (e.g., cell sector in the network) and/or server information such as server IP address from which session data was being sent to the UE 404 during the session which was transferred/migrated. Operation proceeds from step 462 to step 464.

In step 464, the correlator 410 (e.g., correlator 210 of system 200) transmits/communicates the modified/corrected network 1 OSS data back to the network 1 core 402 (e.g., MSO OSS 248) via message 466. Operation proceeds from step 464 to step 468.

In step 468, the network 1 core 403 (e.g., MSO OSS 248) receives the modified/corrected network 1 OSS data. Operation proceeds from step 468 to step 470.

In step 470, the network 1 core 402 (e.g., MSO OSS 248 element of the MSO network core 238) takes an action based on the modified/corrected network 1 OSS data. For example, the network 1 core 402 (e.g., MSO OSS 248) may, and in some embodiments, does modifies power and/or spectrum assignments to base station when session drop thresholds are exceeded in a cell or cell sector of the network. Note that the accuracy of the KPI network session drops affects when this threshold will be exceeded and therein affects the efficient operation of network 1 to maximize its spectrum and/or provide services at specific quality levels.

The signaling flow/method while described in connection with the example of network 1 being MSO network 204 and network 2 being MNO network 202 can also be implemented with network 1 being MNO network 202 and network 2 being MSO network 204.

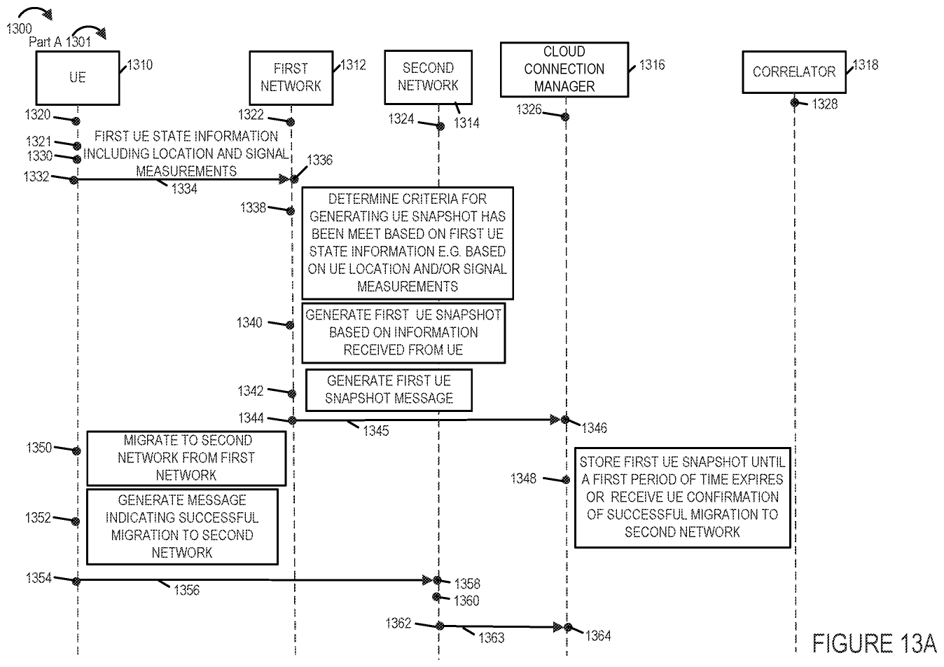

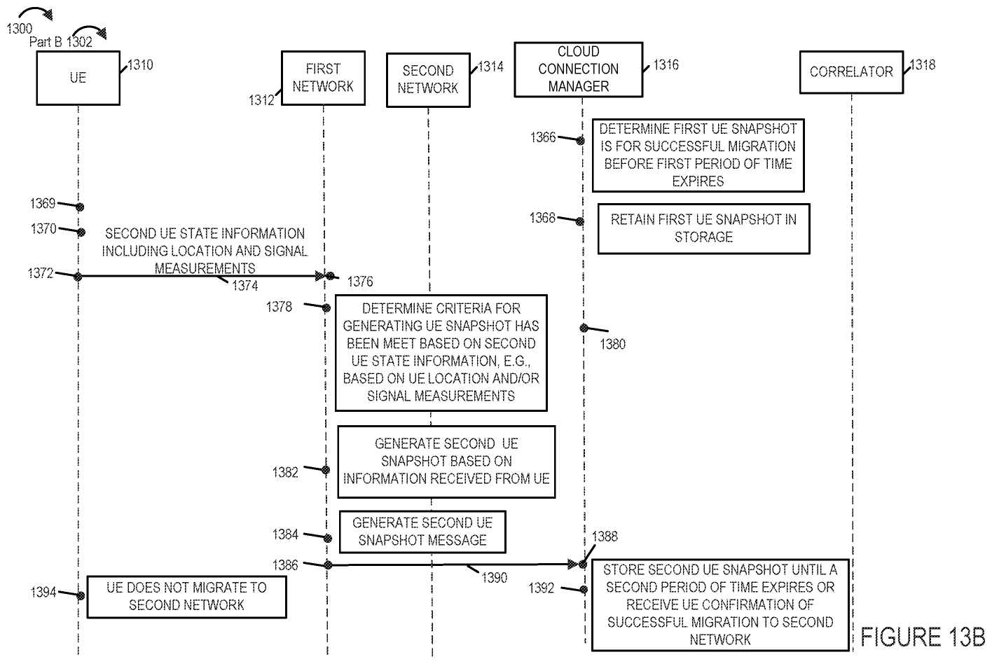

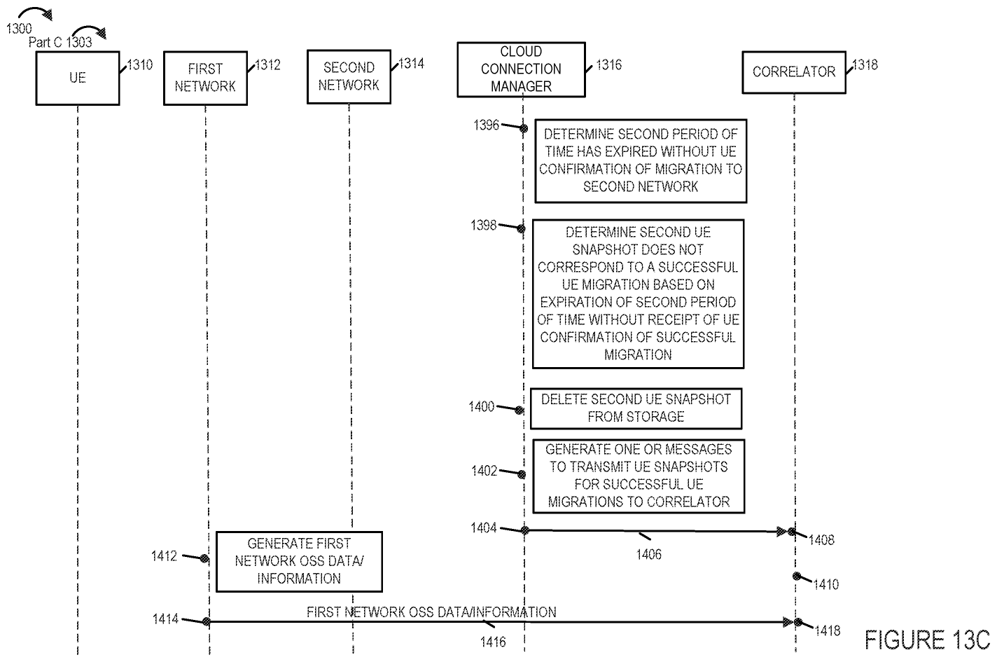

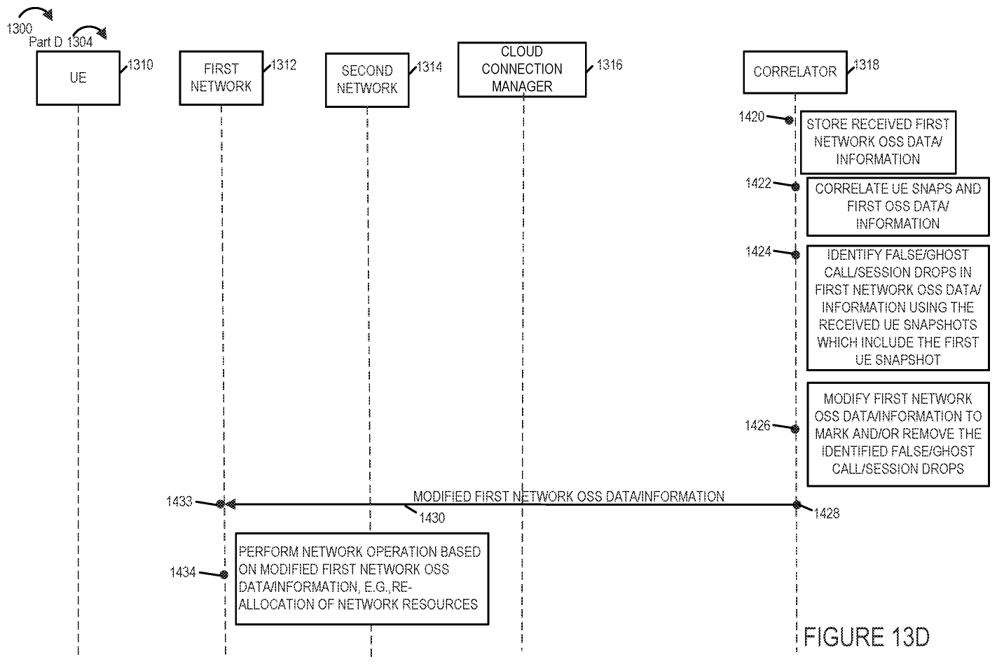

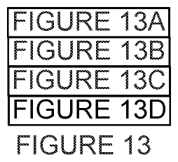

FIG. 13 comprises FIG. 13A, FIG. 13B, FIG. 13C, and FIG. 13D. FIG. 13A is the first part (Part A 1301) of a signaling diagram which illustrates the steps and signaling of an exemplary method 1300 in accordance with an embodiment of the present invention. FIG. 13B is the second part (Part B 1502) of a signaling diagram which illustrates the steps and signaling of an exemplary method 1300 in accordance with an embodiment of the present invention. FIG. 13C is the third part (Part C 1303) of a signaling diagram which illustrates the steps and signaling of an exemplary method 1300 in accordance with an embodiment of the present invention. FIG. 13D is the fourth part (Part D 1504) of a signaling diagram which illustrates the steps and signaling of an exemplary method 1300 in accordance with an embodiment of the present invention.

While it will be readily understood that additional steps and signaling are performed in connection with communicating information, messages, and packets between devices, the method 1300 focuses on and discusses the steps and signaling for understanding the invention. Elements or steps with the same reference numbers used in different figures are the same or similar and those elements or steps will not be described in detail again. The signaling diagram/method 1300 is implemented by a system including a Dual SIM Dual subscriber user equipment device DSDS UE 1310, a first network 1312, a second network 1314, a cloud connection manager 1316, and a correlator 1318.

The DSDS UE 1310 is a wireless device, e.g., a mobile device such as by way of example a mobile phone, smart phone, laptop, tablet, with a first SIM card with credentials to access a first mobile network operator's network and a second SIM card with credentials to access a second mobile network operator's network. The first mobile network operator's network being a first wireless network having a first set of spectrum available for use. The second mobile network operator's network including a second wireless network which utilizes spectrum different than the first wireless network for wireless communications. In some embodiments the first wireless network and the second wireless network are part of a Hybrid Mobile Network Operator system or a Hybrid-MVNO (H-MVNO) system which is capable of offloading traffic from a MNO network (e.g., Verizon network) to a cable company's Wi-Fi network and to the MSO-owned mobile network (e.g., Charter network). The first network 1312 including the first wireless network and a first network core. The second network 1314 including the second wireless network and a second network core. In some embodiments, the first network is a MNO network and the second network is a MSO network. In some embodiments, the first network is a MSO network and the second network is an MNO network.

In some embodiments, the first network is a cellular network and second network is a Citizens Broadband Radio Service network.

In some embodiments, the first network is a large cell system and the second network is a small cell system with the first and second network having overlapping cell coverage. In some embodiments, the first network cell coverage encompasses all of or the majority of the second network's cell coverage. In some such embodiments, the first and/or second wireless network is a Long Term Evolution network utilizing 5G New Radio (NR) technology. In some embodiments, the second wireless network offloads traffic from the first wireless network. In some such embodiments, the second network operator (e.g., which operates the HMNO network system, is a Mobile Virtual Network Operator (MVNO) operator for which the first network operator (e.g., Verizon), which operates the first wireless network and which provides network services, e.g., wireless network services, to the second wireless network operator (e.g., Charter). In some such embodiments, the first wireless network operator is a Mobile Network Operator or a carrier (e.g., Verizon).

The DSDS UE 1310 includes a dual SIM card and is a subscriber of both the first network operator's services and the second network operator's services. This allows the DSDS UE 1310 to connect to and communicate with devices, e.g., wireless base stations and user equipment devices in both the first wireless network and the second wireless network. The DSDS UE 1310 includes a connection manager which manages communications with both the first network and second network, e.g., handoff also referred to as migration or transfer of the DSDS UE 1310 from the first network to the second network and from the second network to the first network. The cloud connection manager 1316 is a network entity located in a cloud system that manages and/or coordinates UE connection handoffs (also referred to as transfers and migrations) between the first and second networks as UEs move between the networks. The correlator 1318 is a network equipment device such as for example a database server system that stores, correlators and modifies data (e.g., OSS data, call detail records and/or session data records).

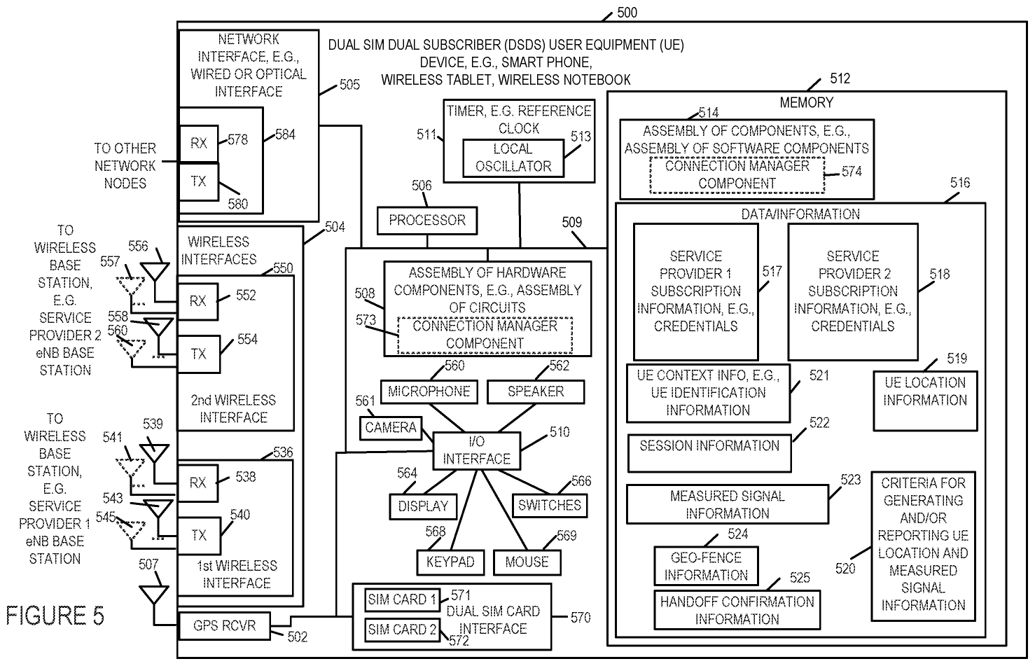

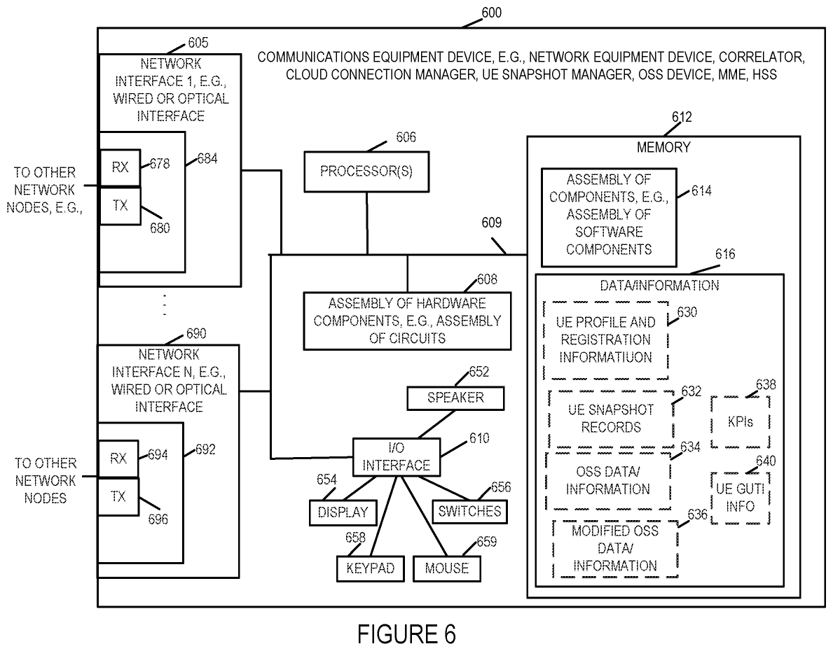

In some embodiments, the DSDS UE 1 1310 is implemented in accordance with user equipment device 500 shown in FIG. 5. In some embodiments, the network equipment devices in the core network of the first network 1312 and the second network 1314 are implemented in accordance with the communications equipment device 600 shown in FIG. 6. In some embodiments, the wireless base stations of the first network 1312 and the second network 1314 are implemented in accordance with wireless base station 700. In some embodiments, the cloud connection manager 1316 and correlator 1318 are implemented in accordance with the communications equipment device 600.

The signaling diagram/method 1300 may be, and in some embodiments is, implemented using exemplary system 200 of FIG. 2. In one such exemplary implementation, the system is A Hybrid Mobile Virtual Network Operator system wherein the first network 1312 is the MNO network 202 of system 200 implemented as a large cell network. The second network is the MSO network 204 of system 200 implemented as a small cell network with the coverage of the MNO network 202 encompassing all or most of the MSO network 204. The MSO network 204 offloading sessions, e.g., data sessions from the MNO network. The UE 1310 is UE N 207 of system 200 which is a Dual SIM Dual Subscriber user equipment device. The cloud connection manager 1316 is cloud connection manager 208 of the system 200. The correlator 1318 is the correlator 208 of system 200. However, it should be understood that the method 1300 is not limited to the exemplary system 200 and may be, and is used, on other systems and system configurations. The signaling diagram/method 1300 illustrates the generation, message flow and usage of UE snapshot information in accordance with an exemplary embodiment of the present invention.

The method 1300 includes Part A 1301 shown on FIG. 13A, Part B 1302 shown on FIG. 13B, Part C 1303 shown on FIG. 13C and Part D 1304 shown on FIG. 13D. The method 1300 starts in start step 1320 of Part A 1302 shown on FIG. 13A. Operation proceeds from start step 1320 and proceeds in parallel to steps 1321, 1322, 1324, 1326, and 1328.

In step 1321, UE 1310 (e.g., UE N 207 of system) connects to and begins receiving services from the first network 1312 (e.g., network 202 of system 200). UE N 207 being in the coverage area of a wireless base station (e.g., wireless base station 216) of the first network (e.g., MNO network 202) but not in the coverage area of the second network 1314. The UE 1310 includes a connection manager which manages whether the UE 1310 is connected to the first network or the second network. The UE 1310 includes is a Dual SIM Dual subscriber mobile device with one SIM card and a first set of credentials for connecting to the first network 1312 and a second SIM card and a second set of credentials for connecting to the second network 1314. The connection manager on the UE 1310 managing which of the two networks the UE 1310 is connected to with respect to each of its sessions. The UE 1310 has two simultaneously active communications sessions (a first session being a call session (e.g., a Voice Over Internet Protocol session) and a second communications session (e.g., a data session such a Youtube data session wherein videos are downloaded or streamed from a Google Youtube IP server) with the first network 1312.

In step 1322, the first network generates a geo-fence around the wireless coverage area of the second network (e.g., MSO wireless network 232). The first network may, and in some embodiments does, establish the geo-fence around the wireless coverage area of the second network by storing the coordinates of the geographical locations around the edge of the wireless coverage of the second network in one or more entities in the first network (e.g., entities in the MNO network core 218 for example the UE snapshot manager 227 and/or the OSS 228) which define the geo-fence. System 300 of FIG. 3 may be used to illustrate the geofence. For example, the geo-fence 302 around the coverage area of small cells 204, 206 and 308 may be the geo-fence around the wireless coverage area of the second network which is the MSO wireless network 232 and the larger cell 315 is part of the wireless coverage area of the first network which is the MNO wireless network 213.

In step 1324, the second network generates a geo-fence around the wireless coverage area of the second network (e.g., MSO wireless network 232). The second network may, and in some embodiments does, establish the geo-fence around the wireless coverage area of the second network by storing the coordinates of the geographical locations around the edge of the wireless coverage of the second network in one or more entities in the second network (e.g., entities in the MSO network core 238 for example the UE snapshot manager 247 and/or the OSS 248) which define the geo-fence.

In step 1326, the cloud connection manager receives information from the UE 1310 connection manager regarding the status of the connection with first network and coordinates with the entities in the first network and second network on preparing the networks for potentially handing off the UE's first and/or second communications sessions from the first network to the second network. The handoff may be, and in some embodiments is, for all active sessions or in some embodiments is for selective handoff of sessions, e.g., offloading of sessions of a typical type or associated with a particular server IP address (e.g., data sessions from IP addresses corresponding to Youtube data sessions). Handoffs of UE and/or communications sessions from one network to another network is also referred to as migrations and/or transfers herein.

In step 1328, the correlator 1318 is initialized.

Operation proceeds from steps 1321, 1322, 1326, and 1328 to step 1330.

In step 1330, UE 1310 generates first UE state information for the UE 1310. UE 1310 includes a connection manager that generates the first UE state information. The generation of the first UE state information may be, and typically is triggered by the UE 1310 (e.g., UE 1310 connection manager) determining that a trigger event has occurred e.g., signal measurements meet or exceed one or more threshold values (e.g., RSRP threshold value or a RSRQ threshold value) and/or the UE's location with respect to the geo-fence around the second network (e.g., being within a threshold distance of the geo-fence). The trigger event is an event which indicates that the UE 1310 is on the verge of losing its connection with the first network (e.g., because UE 1310 is about enter the coverage area of the second network and one or more sessions of the UE may be offloaded (e.g., handed off, transferred or migrated from the first network to the second network).

The first UE state information includes location information, e.g., GPS coordinate information and signal measurements (e.g., RSRP and RSRQ signal measurements from wireless base station from which the UE 1310 is receiving reference signals e.g., UE 1310 is UE N 207, may and in some embodiments does receive reference signals from wireless base station 216 and 214 from MNO wireless network 212 and wireless base station 234 from MSO wireless network 232 with wireless base station 236 being out of range. In addition to the UE 1310 location information and signaling measurements, the UE state information may, and in some embodiments does, include UE 1310 session context information for each of its active sessions, e.g., the first session and the second session. The state information may, and in some embodiments does, include UE identification information (first GUTI and second GUTI, IMSI, etc.), credential information, address of server to which UE is connected with respect to a session, packet level information for a session (e.g., packet sequence number), session type for a session (e.g., audio, video, voice, data), transport protocol type for session (RTP or UDP). Operation proceeds from step 1330 to step 1332.

In step 1333, UE 1310 generates and transmits message 1334 with the first UE state information to the first network 1312, e.g., to an entity, e.g., UE snapshot manager or OSS, in the first network core via the wireless base station to which UE 1310 is connected. For example, when UE 1310 is UE N 207 the message 1334 is communicated to the UE snapshot manager 227 and/or the OSS 228 in the MNO network core 218 via the wireless base station 216 to which it is connected. Operation proceeds from step 1332 to step 1336.

In step 1336, the first network 1312 (e.g., UE snapshot manager 227 and/or OSS 228 located in the MNO network core 218 of MNO network 202) receives the message 1334. Operation proceeds from step 1336 to step 1338.

In step 1338, the first network 1312 (e.g., a first core network entity such as the UE snapshot manager 227 and/or OSS 228) determines whether criteria for generating a UE snapshot has been meet based on the first UE state information, e.g., based on the UE location information and/or signal measurements. Examples of criteria for generating a snapshot were previously described. For example, the location of the UE 1310 with respect to a geo-fence or the values of signal measurements such as RSRP and RSRQ values of reference signals received from the first and second networks with respect to threshold values (e.g., RSRP value for the second network is meets or exceeds a RSRP threshold value and/or RSRQ value for the second network meets or exceed a RSRQ threshold value for the second network). The RSRP value and RSRQ values for the first network may exceed the RSRP and RSRQ threshold values respectively and even be better than the values of the second network as the first network's coverage area includes all or almost all of the second network's coverage area. In this example, the traffic, e.g., communications sessions, are being offloaded from the first network (e.g., MNO network operated as a MVNO) to the second network (MSO). This is being done to reduce the load and cost of utilizing the first network (e.g., MNO network operator Verizon) which is owned by a different operator than the second network (e.g., MSO network operator (e.g., Charter). The first network owner charging the second network owner for use of its network by the UE 1310 subscriber. Operation proceeds from step 1338 to step 1340.

In step 1340, the first network (e.g., an entity in the first network core such as for example, the UE snapshot manager (e.g., UE snapshot manager 227 or OSS 228 of MNO network core 218) generates a first UE snapshot for the UE 1310 based on information received from UE 1310 (e.g., one or more pieces of the UE state information received in message 1334 such as the UE identification information). The first UE snapshot also includes a timestamp. The timestamp indicates when the UE snapshot was generated and/or when the UE information including in the snapshot was generated (e.g., location of the UE and/or signal measurements). In some embodiments, the first UE snapshot is generated based on additional information about UE 1310 and the active session of UE 1310 obtained from an MME (e.g., MME 220) in the first network core and/or HSS (e.g., HSS 222). The MME providing connectivity information about the UE 1310 and its active session (e.g., first communications session and second communications) and the HSS providing UE 1310 profile information (e.g., subscriber information, UE identification information, etc.). Operation proceeds from step 1340 to step 1342.

In step 1342, the first network (e.g., an entity in the first network core such as the UE snapshot manager 227 or OSS 228) generates a first UE snapshot message 1345 which includes the first UE snapshot. Operation proceeds step 1342 to step 1344.

In step 1344, the first network (e.g., an entity in the first network core such as the UE snapshot manager 227 or OSS 228) transmits the first UE snapshot message to the cloud connection manager 1316 (e.g., cloud connection manager 208 of system 200). Operation proceeds from step 1344 to step 1346.

In step 1346, the cloud connection manager 1316 receives and processes the first UE snapshot message 1345. Operation proceeds from step 1346 to step 1348.

In step 1348, the cloud connection manager 1316 extracts and stores the first UE snapshot in memory of a storage device until a first period of time expires or the cloud connection manager from UE 1310 a confirmation of the successful migration of UE 1310 or first communications session or the second communications session to the second network from the first network. Operation proceeds from step 1348 to step 1350.

UE 1310 migrates from the first network to second network with respect to one or more active communications sessions. For example, the UE 1310 connection manager may be, and in some embodiments is, configured to maintain voice sessions on the first network (e.g., large cell MNO network) while migrating or off-loading data sessions from the first communications network (e.g., MNO network) to the second communications network (e.g., small cell MSO network). The UE 1310 connection manager migrates (i.e., transfers or hands off) the second communications session when it is a data session to the second network while maintaining the first communications session which is a voice communications session with the first network. In some embodiments, UE 1310 connection manager is configured to migrate and/or transfer and/or hand off all communications sessions from the first network to the second network. In some embodiments, the UE 1310 connection manager is configured to handoff/transfer/migrate communications session based on session type and/or IP address of the far end device, e.g., IP server with which the UE 1310 is connected, e.g., address of Youtube server. Upon the successful migration/handoff/transfer of the one or more active communications sessions, operation proceeds from step 1350 to step 1352.

In step 1352, the UE 1310 connection manager generates message 1356 with information indicating that the one or more active communications sessions have been successfully migrated to the second network. The message 1356 may, and in some embodiments does, include UE identification information and a session identifier for each of the successfully migrated/transferred/handed off communications sessions. Operation proceeds from step 1352 to step 1354.

In step 1354, the UE 1310 (e.g., connection manager located on the UE 1310) transmits the message 1356 to the second network 1314 (e.g., the message 1356 is transmitted to an entity in the second network core (e.g., to UE snapshot manager 247 or OSS 248 via wireless base station 234 to which the UE 1310 was migrated with respect to at least the second communications session. Operation proceeds from step 1354 to step 1358.

In step 1358, the second network 1314 (e.g., an entity in the second network core 238 (e.g., to UE snapshot manager 247 or OSS 248) receive the message 1356. Operation proceeds from step 1358 to step 1360.

In step 1360, the second network 1312 (e.g., an entity in the second network core 238 (e.g., UE snapshot manager 247 or OSS 248) generates confirmation message 1363 based on message 1356. The confirmation message 1363 includes information confirming the successful migration of one or more UE communications sessions. The information including UE identification information (e.g., GUTI 1 and GUTI 2 for the UE) and communications session identification information which identifies each of the UE communications sessions which were successfully handed off/transferred/migrated from the first network to the second network. In some embodiments, the message includes a timestamp. In some embodiments, the confirmation message 1363 is a forwarded version of confirmation message 1354. Operation proceeds from step 1360 to step 1362.

In step 1362, the second network 1314 (e.g., an entity in the second network core (e.g., the UE snapshot manager 247 or OSS 248) transmits the confirmation message 1363 to the cloud connection manager 1316 (e.g., cloud connection manager 208 of system 200). Operation proceeds step 1362 to step 1364.

In step 1364, the cloud connection manager 1316 receives the confirmation message 1363. In this example, the confirmation message 1363 is received prior to the expiration of the first period of time. Operation proceeds from step 1364 to step 1366 shown on FIG. 13B.

In step 1366, the cloud connection manager 1316 (e.g., cloud connection manager 208 of system 200) using the information received in the confirmation message 1363 (e.g., UE identification information and session identification information) determines that the first UE snapshot is for/corresponds to a UE snapshot taken before a successful migration of the UE 1310 and/or one or more active sessions of UE 1310 being migrated. The determination that the first UE snapshot is for a successful migration is completed before the expiration of the first period of time. Operation proceeds from step 1366 to step 1368.

In step 1368, the cloud connection manager 1316 retains the first UE snapshot in storage (e.g., memory or a storage device) and does not delete the first UE snapshot at the expiration of the first period of time. In this example, UE snapshots are retained by the cloud connection manager for a period of time such as for example, 15 minutes, so that a plurality of UE snapshots can be identified by the cloud connection manager 1316 as corresponding to/being for successfully confirmed migrations/handoffs/transfers and accumulated before transmitting the UE snapshots to Correlator 1318. Operation proceeds from step 1368 to step 1369.

In step 1369 some time has passed since the migration of UE 1310 to the second network and the first and second communications sessions have been terminated and the UE 1310 has moved location to be within the coverage area of the first network 1312. In step 1369, the UE 1310 is again connected to the first network 1312 and currently has a third communications session active which is supported by the first network 1312. Operation proceeds from 1369 to step 1370.

In step 1370, UE 1310 generates second UE state information including UE 1310 location information and signal measurements (e.g., measuring RSRP and RSRQ values) at a later time than the first state information was generated. The location and signal measurements having different values as the UE 1310 has moved since the first UE state information was generated. The location information being geographical location information such as GPS coordinates and/or cell information (e.g., cell sector) information. Operation proceeds from step 1370 to step 1372.

In step 1372, UE 1310 generates and sends/transmits message 1374 to the first network 1312. The message 1374 includes the second UE state information including UE identification information, UE location information and signal measurements, the second UE state information in some embodiments includes the same categories of information as described with the respect to the first UE state information. The message 1374 is sent to an entity in the first network (e.g., the UE snapshot manager or OSS) via a wireless base station of the first network. Operation proceeds from step 1372 to step 1376.

In step 1376, the first network 1312 (e.g., the UE snapshot manager or OSS in the first network core) in the first network 1312 receives the message 1374. Operation proceeds from step 1376 to step 1378.

In step 1378, the first network 1312 (e.g., the UE snapshot manager or OSS entity in the first network core) determines that the criteria for generating a UE snapshot has been met based on the second UE state information (e.g., UE 1310 location and/or signal measurements) received in the message 1374. Operation proceeds from step 1378 to step 1382.

In step 1380, the cloud connection manager 1316 accumulates other UE snapshots from other UEs in the first network for which it has received confirmation from the UE corresponding to the UE snapshot that the UE and/or communication session(s) of the UE have been successfully migrated/transferred/handed off to the second network.

In step 1382, the first network 1312 (e.g., the UE snapshot manager or the OSS in the first network core of the first network) generates a second UE snapshot based on the information received from UE 1310 in the message 1374. In some embodiments, the second UE snapshot is also generated using information obtained from the first network MME (e.g., UE 1310 connection information such as for example active sessions, cell sector location, etc.) and/or information obtained from the first network HSS (e.g., UE 1310 profile information). The second UE snapshot includes the same categories of information as the first UE snapshot. Operation proceeds from step 1382 to step 1384.

In step 1384, the first network 1312 (e.g., the UE snapshot manager or OSS in the first network core of the first network) generates the second UE snapshot message 1390. Operation proceeds from step 1384 to step 1386.

In step 1386, the first network 1312 (e.g., the UE snapshot manager or OSS) communicates/transmits the generated second UE snapshot message 1390 to the cloud connection manager 1316. Operation proceeds from step 1386 to step 1388.

In step 1388, the second UE snapshot message 1390 is received by the cloud connection manager 1316. Operation proceeds from step 1388 to step 1392.

In step 1392, the cloud connection manager 1316 extracts and stores the second UE snapshot information and/or record from message 1390 and stores it (e.g., in memory or a storage device) until a second period of time expires or the cloud connection manager received UE confirmation of a successful migration to the second network. If a confirmation that the UE 1310 has not successfully migrated/handed off/transferred to the second network within the second period of time, the cloud connection manager will delete the second UE snapshot information/record. Operation proceeds from step 1392 to step 1394.

In step 1394, the UE does not migrate to the second network 1314 but remains in the first network 1312. As a result, no confirmation of migration/handoff/transfer is sent to the cloud connection manager 1316 by UE 1310. Operation proceeds from step 1394 to step 1396 shown on FIG. 13C.

In step 1396, the cloud connection manager 1316 determines that the second period of time has expired without receiving a UE confirmation of migration/transfer/handoff of the UE 1310 to the second network. Operation proceeds from step 1396 to step 1398.

In step 1398, the cloud connection manager determines the second UE snapshot does not correspond to a successful UE migration based on expiration of the second period of time without receipt of a UE confirmation of successful migration/transfer/handoff being received from UE 1310. Operation proceeds form step 1398 to step 1400.

In step 1400, the cloud connection manager 1316 deletes the second UE snapshot from storage (e.g., from memory or a storage device). Operation proceeds from step 1400 to step 1402.

In step 1402. The cloud connection manager 1316, generates one or more messages 1406 to transmit/communicate UE snapshot information (e.g., UE snapshots for successful UE migrations/handoffs/transfers) to the correlator 1318. These UE snapshots for successful UE migrations/handoffs/transfers are those UE snapshots for which the cloud connection manager 1316 received a confirmation from the UE for which the snapshot was provided that the UE was successfully migrated/transferred/handed off with respect to one or more active sessions and which had been retained by the cloud connection manager 1316 upon receiving the UE confirmation of successful migration/transfer/handoff. Operation proceeds from step 1402 to step 1404.

In step 1404, the cloud connection manager 1316 communicates/transmits the one or more generated messages with UE snapshots 1406 to the correlator 1318 (e.g., correlator 210 of system 200). Operation proceeds from 1404 to step 1408.

In step 1408, the correlator 1318 receives the one or messages with UE snapshot information (e.g., UE snapshots corresponding to UEs with successful migrations/transfers/handoffs. Operation proceeds from step 1408 to step 1410.

In step 1410, the correlator 1318 processes message 1406 and extracts the UE snapshot information (e.g., the UE snapshots). Operation proceeds from step 1410 step 1412.

In step 1412, the first network (e.g., the OSS 228 in the MNO core network 218) generates first network OSS data/information. In some embodiments, the first network OSS data/information include call detail records, communications session data records, Key Performance Indicator metrics such as for example overall count of dropped communications sessions, count of dropped communications sessions per cell/sector, dropped communications sessions for each base station in the first network and/or by location and/or time, measurements of dropped data throughput per sector per time, underlying data records from which the KPIs are generated. The call detail records and communications session data records include UE identification information, session identification information, session drop information, timestamp information, location information of session drop. Operation proceeds from step 1412 to step 1414.

In step 1414, an entity in the first network 1312 (e.g., the OSS 228 of MNO network core 218 of system 202) transmits/communicates message 1416 which includes the first network OSS data/information to the correlator 1318. Operation proceeds from step 1416 to step 1418 shown on FIG. 13D.

In step 1418, the correlator 1318 receives and processes the message 1416 from the first network 1312 (e.g., from the OSS 228). Operation proceeds from step 1418 to step 1420 shown on FIG. 13D.

In step 1420, the correlator 1318 stores the received first network OSS data/information. Operation proceeds from step 1420 to step 1422.

In step 1422, the correlator 1318 correlators the UE snapshot information (e.g., UE snapshots) and OSS data/information (e.g., OSS session records of dropped sessions). Operation proceeds from step 1422 to step 1424.

In step 1424, the correlator 1318 identifies false/ghost call/session drops in the first network OSS data/information using the received UE snapshot information (e.g., the UE snapshots) which include the first UE snapshot. This includes identifying the communications session data records for the UE 1310 communications session(s) which were recorded as being dropped but which were successfully migrated/handed off/transferred to the second network using the first UE snapshot information. In some embodiments, correlator 1318 uses the UE identification information (e.g., GUTI information, session identification information (e.g., session ID), location information (cell sector and/or geographical location) and timestamp information included in the UE snapshot to identify the false/ghost session drops. In some embodiments, the correlator 1318 uses the correlated UE snapshots and first network OSS records to identify those communications sessions which were incorrectly identified as being dropped but which were in fact transferred/handed off/migrated to the second network. Operation proceeds from step 1424 to step 1426.

In step 1426, the correlator 1318 modifies the first network OSS data/information to mark and/or remove the identified false/ghost call/sessions drops from the first network OSS data/information. In some embodiments, the OSS KPI data for dropped calls/sessions and/or data throughput drop KPIs is modified to correct for the falsely identified dropped calls/sessions which were migrated included the session related to the first UE snapshot. Operation proceeds from step 1426 to step 1428.

In step 1428, one or messages 1430 are generated and transmitted/communicated to the first network 1312 (e.g., OSS 228 in the MNO network core 218). The one or message 1428 including the modified first network OSS data/information including the modified/corrected KPI information. Operation proceeds from step 1428 to step 1432.

In step 1432, the first network 1312 (e.g., OSS 228 in the MNO network core 218) receives and processes the one or more messages 1428 including the modified first network OSS data/information including the modified/corrected KPI information. Operation proceeds from step 1432 to step 1434.

In step 1434, one or more entities in the first network 1312 (e.g., OSS system 228 in the MNO network core 218) performs network operation(s) based o the modified first network OSS data/information, e.g., operation(s) to re-allocate network resources such as for example spectrum and/or power limits to base stations (e.g., base stations 214 and 216). For example, using the corrected KPIs on session drops the OSS identifies the base station(s) cells and/or cell sector having drops above a first threshold and modifies the transmit power for the base station experiencing the session drops above the first threshold and/or modifies the spectrum allocated to the base station.

It should be understood that while method 1300 has been explained with respect to UE 1310 moving from the first network to the second network the method may be used for UEs moving from the second network to the first network. In some embodiments, the cloud connection manager receives UE snapshots and OSS data/information from both networks and modifies the first network OSS data/information and the second network OSS data/information and sends the modified OSS data/information back to their respective networks which use the modified data to determine and implement network configuration operations including for example determining which sessions to transfer/migrate, adjust power transmission levels for base stations and/or the allocation of spectrum among the network's base stations. While the method 1300 has only been described with respect to a single UE and a few base stations the method 1300 is applicable when there id a plurality of UEs, typically thousands, and a numerous base stations.

It should be understood that the operation(s), step(s), and function(s) described in connection with the first network, the second network, the cloud connection manager, and the correlator may be implemented by network entities such as network equipment device(s), network service function(s) and/or other components or systems located in the identified network or cloud system or environment.

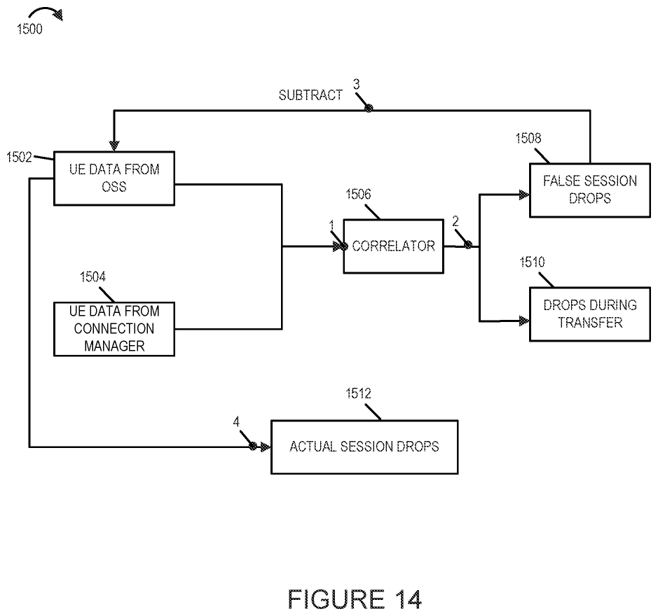

FIG. 14 illustrates another exemplary method 1500 embodiment of the present invention which shows how actual communications session drops can be determined. In step 1 user equipment data from OSS 1502 (e.g., communications session records with session drop reason being the reason for termination) and user equipment data from the connection manager 1504 (e.g., UE snapshot records of successful session transfers) are input to the correlator 1506. In step 2, the correlator 1506 identifies and outputs the false session drops 1508 from session drops during transfer 1510. The false session drops 1508 being communications sessions that were actually successful transfers from a first wireless network to a second wireless network. The UE data from OSS 1502 being data from the first wireless network. The correlator 1506 identifying the false session drops by comparing the information (e.g., UE identification information, session identification information, time of drop information, location of session drop information) in the OSS data 1502 (e.g., communications session records) with the information in the UE data from connection manager (e.g., UE snapshot records of successful transfers from a first wireless network to a second wireless network). In step 3 the false session drop records 1508 are removed from the UE data from the OSS 1502 (e.g., communications session records). In step 4, the actual session drops (e.g., the actual session drop records 1512 are outputted after the false session drops have been subtracted/removed from the UE data from OSS 1502. In various embodiments, the correlator performs the step of subtracting or removing the identified false session drop records from the UE OSS data to output the actual session drop records. The method 1500 can be also be used for transfers from the second wireless network to the first wireless network by having the UE data from OSS 1502 being the OSS data from the second wireless network and the UE data from the connection manager 1504 including UE snapshot records of successful session transfers from the second wireless network to the first wireless network.

In various embodiments, the OSS data from the first wireless network and the OSS data from the second wireless network are confidential to the respective operator of the first wireless network and the second wireless network and the operators are unwilling to share the information. In such situations, the operator of the correlator is a third party with which the operator of the first wireless network and the operator the second wireless network enter into a contract for services to provide accurate OSS data on session drops for their respective networks. In this way, neither the first wireless network operator and the second wireless network operator can have accurate communications session drop information to utilize in optimizing their respective networks performance without sharing their confidential information. The session drops themselves as well as data derived from the session drops (such as for example, location, count, timing of drops) are all key performance indicators used in investigating and optimizing a wireless network's performance.

FIG. 11 illustrates an exemplary UE snapshot record 1100. The UE snapshot record 1100 is represented as an array but can be implemented in other data structures. The UE snapshot includes a first column 1101 and a second column 1102 and rows 1103, 1106, 1110, 1114, 1116, 1118, 1122, 1126, 1130, and 1134. Each row of the UE snapshot record 1100 includes a description of an exemplary UE snapshot record field in column 1101 and an exemplary description of the corresponding information which is typically contained in the field shown in column 1102 of the row. The fields of the exemplary UE snapshot record 1100 are UE snapshot record identifier (entry row 1103, column 1101), timestamp (entry row 1106, column 1101), server information (entry row 1110, column 1101), UE credentials (i.e., UE identification information (entry row 1114, column 1101), session identification information (entry row 1118, column 1101), packet flow information for each active session (entry row 1122, column 1101), UE location information (entry row 1126, column 1101), reason for snapshot (entry 1130, column 1101), and UE signal measurements (entry row 1134, column 1101).

The UE snapshot record ID field contains information to identify the specific UE snapshot record such as for example a unique record identifier number (entry row 1103, column 1102). The timestamp field contains the time of the UE snapshot record's creation (entry row 1106, column 1102) and/or time UE generated data included in snapshot record (e.g., time signal measurements and/or UE location information was generated by UE). The server information field includes Internet Protocol (IP) address information for one or more far end server(s) with which the UE was communicating (entry row 1110, column 1112).

The UE credentials (i.e., UE identification information) includes UE context information which can be used to identify the UE (e.g., International Mobile Subscriber Identity (IMSI), International Mobile Station Equipment Identity (IMEI), Cell Radio Network Temporary Identifier (C-RNTI), GUTI-1 assigned by first network MME, GUTI-2 assigned by second network MME)). Cell Radio Network Temporary Identifier, The C-RNTI is a UE identifier allocated by a controlling RNC and it is unique within one cell controlled by the allocating CRNC. C-RNTI can be reallocated when a UE accesses a new cell with the cell update procedure. The GUTI is the Globally Unique Temporary ID assigned to the UE by an access network management node (e.g., MME). The GUTI is made up of two portions. The two portions are the globally unique Globally Unique Mobility Management Entity Identifier (GUMMEI), which identifies the network, and the M-TMSI, which identifies the device. The GUMMEI portion of the GUTI includes several sub-parts. These sub-parts are: the Mobile Network Code (MNC), the Mobile Country Code (MCC), and the MME ID (Mobility Management Entity ID). The Mobility Management Entity is the primary control node for the LTE access network. MMEs are usually clustered in pools, and the MME ID identifies both the MME pool and the node within that pool.

The session identification information field contains the session identification information such as for example Packet Data Network ID (PDN ID), Evolved Packet System Bearer Identifier (EPS bearer ID) which is used identify an EPS bearer (Default or Dedicated) per an UE, Linked EPS Bearer ID (LBI) which is used to identify the default bearer associated with a dedicated EPS bearer, and Tunnel End Point Identifier (TEID) which is used to identify the end point of a GTP tunnel when the tunnel is established (entry row 1118, column 1120).

The packet flow information field contains the packet flow information for each active session such as for example, packet number, packet sequence number when UE snapshot was taken (entry row 1122, column 1124).

The UE location information field contains location information for the UE including for example, UE geographical location information such as for example, GPS coordinates, and UE location in wireless network (e.g., cell and/or sector location information for the wireless network to which it is connected) (entry row 1126, column 1128).

The reason for snapshot field includes information on why the snapshot was generated for example, what criteria was met causing the UE snapshot to be generated. For example, was the UE snapshot generated in response to a location based trigger, a quality based trigger, or a combined location and quality based trigger (entry row 1130, column 1132).

The UE signal measurements field contains UE signal information (e.g., RSRP and RSRQ measurements) generated by the UE device and reported to the network core with the UE's location information (entry row 1134, column 1136). The UE signal information may, and typically does, include the quality based trigger information discussed in connection with the reason for snapshot generation field 1130.

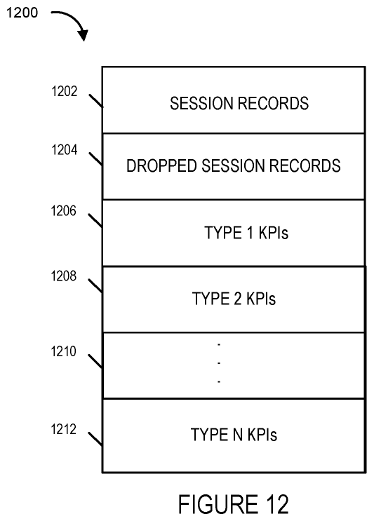

FIG. 12 illustrates exemplary OSS data 1200. The exemplary OSS data 1200 includes communications session records 1202, dropped communications session records 1204, and a plurality of KPIs grouped by type (KPIs Type 1 1206, KPIs Type 2 1208, 1210, KPIs Type N 1212, where N is an integer number greater then 2 and . . . 1210 indicates additional KPIs of different types. The dropped session records 1204 are also consider KPIs. The dropped session records 1204 are a plurality or set of session records which are records with information indicating the communications session corresponding to each of these was recorded as being dropped by the OSS system. The dropped session records generated by the OSS include false drops wherein the communications session was actually successfully transferred to another wireless network. The communications session records include records for each communications session regardless of whether it was a dropped communications session or not. In some embodiments of the invention, the OSS data supplied to the correlator is the full set of communications session records 1202 with each session record including and indication of whether or not the session is a dropped session. In some embodiments, the OSS data supplied to the correlator is just the dropped session records 1204 in which case the OSS has already identified the session records corresponding to the sessions the OSS has recorded as being dropped. The type 1 KPIs to Type N KPIs are KPIs of different types generated by the OSS system. Exemplary types of KPIs include count of session drops for the entire system over a given time period, count of session drops by a particular base station during a given time period, count of session drops in a given cell or cell sector in a given time period, count of data throughput drop in a given cell or cell sector in a given time period, count of session drops based on UE device type in a given time period, count of session drops based on system location in a given time period, count of session drops based on physical location (e.g., GPS coordinates) in a given time period, count of session drops during transfers in a particular location during a given time period, count of session drops by session type and location over a given time period, count of session drops by far end server IP address over a given time period. In various embodiments, the OSS data 1200 or portions of the OSS data 1200 are supplied to the correlator which modifies the supplied data to take into account or correct the false dropped session information included in the OSS data 1200 or portions of the OSS data 1200. For example, by removing, marking or correcting false dropped sessions which are actually successfully transferred sessions using the UE snapshot records of successful transferred sessions. For example, the KPIs which are counts can be adjusted to reflect the removal of false dropped sessions from the KPI counts. The dropped session records which are identified as false dropped sessions can be removed or marked. The session records can be updated so that the false dropped sessions no longer indicate that the session was dropped but instead that it was successfully transferred. In some embodiments, the correlator receives the session records 1202 and/or dropped session records 1204 and generates KPIs such as the different types of KPIs discussed above using the session records 1202 and/or dropped session records 1204 as well as the UE snapshot records the correlator receives from the cloud connection manager. Additional KPIs can include the UE signal measurements of successfully transferred sessions as well as augmented session data records which include additional information from the UE snapshot records not included in the session records received from the OSS system. In some embodiments, instead of the OSS system of a wireless network providing the OSS data to the correlator the correlator receives session data records from an external monitoring system separate from the OSS system which monitors network operations. The correlator uses the monitoring network data in the same manner as described with respect to the OSS data to generate and modify the records to take into account and correct for false session drops.

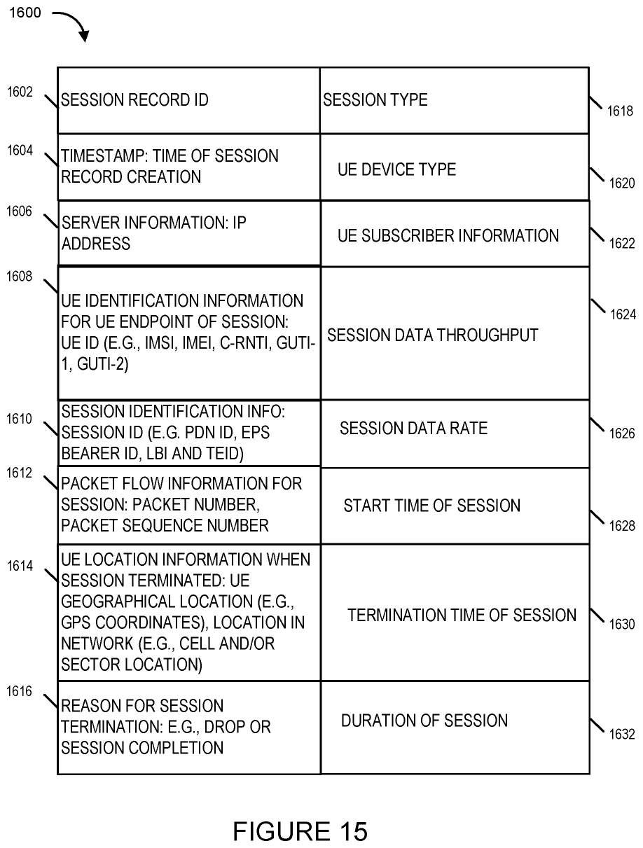

FIG. 15 illustrates an exemplary communications session record 1600. In some embodiments, the communications session records 1202 and/or dropped communications session records 104 are implemented in accordance with communications session record 1600. Communications session record 1600 includes the following fields session record identifier 1602 which is a unique session record identifier for the record, timestamp: time of session record creation 1604, server information: IP address 1606, UE identification information for UE endpoint of session: user equipment ID (e.g., IMSI, IMEI, C-RNTI, GUTI-1, GUTI-2), session identification information: session ID (e.g., PDN ID, EPS bearer ID, LBI, TIED) 1610, Packet Flow information for session: packet number, packet sequence number 1612, UE location information when session terminated (e.g., UE geographical information (e.g., GPS coordinates) and/or location in the wireless network (e.g., cell and/or cell sector location) 1614, reason for session termination (e.g., dropped session or session completed and normal termination) 1616, session type (e.g., real time data session, non-real time data session, voice session, UDP session, RTP session, best effort protocol session, etc.) 1618, User Equipment device type (e.g., mobile phone, tablet, android smartphone, iOS smartphone) 1620, user equipment subscriber information 1622, session data throughput 1624, session data rate 1626, start time of session 1628, termination time of session 1630, duration of session 1632. The correlator compares the data in the UE snapshot records to the data in the session records to identify the communications session records which are false session drops. For example, the correlator can first identify from the session record the reason for the session's termination as determined by OSS is dropped session using field 1616. Second, the correlator can compare the UE identification information 1608 to the UE credential information 1114 in the UE snapshot records, the UE location information when the session terminated 1614 of the session record to the user location information 1126 of the snapshot record, the session identification information 1610 in the session record to the session identification information 1118 in the UE snapshot records, the termination time of session 1630 in the session record to the timestamp 1106 in the UE snapshot record. The server information 1606 of the session record can be compared to the server information 1110 of the UE snapshot record. The UE subscriber information 1622 of the session record can be compared to the UE credentials information 1114 of the UE snapshot records. The results of the comparisons can be used to determine which session records have been identified as dropped session actually are sessions which were successfully transferred to another wireless network. The timestamp and termination of session comparison do not need to be an exact match but can match to within a fixed time window so as to take into account that the UE snapshot is taken prior to the termination of the session. In some embodiments, the user identification information, location information, session identification information and time of session termination and UE snapshot timestamp are the only fields in the UE snapshot and session record to determine if there is a match. In some embodiments, only the user equipment identification, time information and location information are used to determine if there is a match.

FIG. 5 is a drawing of an exemplary user equipment (UE) device 500 in accordance with an exemplary embodiment. UE device 500 is, e.g., a wireless device, e.g., a mobile device such as a cell phone, a smart phone, wireless tablet or wireless notebook. UE device 500 is a dual SIM dual subscriber device that is enabled to communicate with different wireless base stations utilizing different wireless spectrum and/or wireless protocols, e.g., 5G wireless protocol, CBRS wireless protocol or cellular wireless protocol. The UE device 500 can communicate with a first wireless network (e.g., a MNO network) using a first set spectrum using the first of the dual SIM cards and the can communicate with a second wireless network (e.g., a MSO network) using a second set of spectrum using the second of the dual SIM cards. Exemplary UE device 500 includes wireless interfaces 504, a network interface 505, a processor 506, e.g., a CPU, an assembly of hardware components 508, e.g., an assembly of circuits, and I/O interface 510, a GPS receiver 502 coupled to GPS receive antenna 507, a timer 511, e.g., a reference clock including a local oscillator 513, a dual SIM card interface 570 including a first SIM card, SIM card 1 571, corresponding a first service provider, and a second SIM card, SIM card 2 572 corresponding to a second service provider, and memory 512 coupled together via a bus 509 over which the various elements may interchange data and information. UE device 500 further includes a microphone 560, camera 561, speaker 562, a display 564, e.g., a touch screen display, switches 566, keypad 568 and mouse 569 coupled to I/O interface 510, via which the various I/O devices (560, 561, 562, 564, 566, 568, 569) may communicate with other elements (502, 504, 505, 506, 508, 512, 570) of the UE device. Network interface 505 includes a receiver 578 and a transmitter 580. The network interface 505 can be coupled to routers within the home or customer premises or to wired (e.g., cable) or optical (e.g., fiber-optic) networks. In some embodiments, receiver 578 and transmitter 580 are part of a transceiver 584. In some embodiments, the assembly of hardware components 508 includes a connection manager component 573.

Wireless interfaces 504 include a plurality of wireless interfaces including first wireless interface 536 and a second wireless interface 550. The first wireless interface 536 is, e.g., used to communicate with wireless base stations in a first service provider's communications network, e.g., cellular, e.g., gNB or eNB tower base stations of the first service provider's communications network, e.g., using a first set of spectrum and a first communications protocol corresponding to the first service provider (e.g., MNO network service provider such as Verizon). The second wireless interface is, e.g., used to communicate with a device, e.g., a CBSD base station, gNB, or eNB, of a second service provider's communications network (e.g., MSO service provider such as Charter). For example, the second wireless interface is used to communicate with a CBDS, eNodeB, or gNB base station of the second service provider using a second set of spectrum and a second communication protocol corresponding to the second service provider. The first wireless interface 536 includes wireless receiver 538 and a wireless transmitter 540. In some embodiments, receiver 538 and transmitter 540 are part of a transceiver. In various embodiments, the first wireless interface 536 includes a plurality of wireless receivers and a plurality of wireless transmitters. Wireless receiver 538 is coupled to a plurality of receive antennas (receive antenna 1 539, . . . , receive antenna M 541), via which user equipment device 500 can receive wireless signals from other wireless communications devices including a wireless base station, e.g., a cellular wireless base station of the first service provider. Wireless transmitter 540 is coupled to a plurality of wireless transmit antennas (transmit antenna 1 543, . . . , transmit antenna N 545) via which the user equipment device 500 can transmit signals to other wireless communications devices including a cellular wireless base station of the first service provider. The antennas 539, . . . , 541 and 543, . . . , 545 are typically mounted inside the housing of the wireless device but in some embodiments are located outside the user equipment device housing. In some embodiments the various antennas form an antenna array with the antennas pointing in different directions. In some embodiments, one or more of the antennas are included inside the housing of the user equipment device and the user equipment device includes one or more connections to which exterior antennas may be connected.

The second wireless interface 550 includes wireless receiver 552 and a wireless transmitter 554. In some embodiments, receiver 552 and transmitter 554 are part of a transceiver. In various embodiments, the second wireless interface 550 includes a plurality of wireless receivers and a plurality of wireless transmitters. Wireless receiver 552 is coupled to one or more receive antennas (receive antenna 1 556, . . . , receive antenna M 557), via which user device 500 can receive wireless signals from other wireless communications devices including, e.g. an eNodeB, a gNb or a CBSD base station of a second service provider. Wireless transmitter 554 is coupled to one or more wireless transmit antennas (transmit antenna 1 558, . . . , transmit antenna N 560) via which the user equipment device 500 can transmit signals to other wireless communications devices including, e.g., a CBSD, a eNB, or gNb of a second service provider. The user equipment device network interface 505 may be coupled to LAN or WAN networks or routers so that the user equipment device can also obtain services via a hardwired connection in addition to through the wireless interfaces, e.g. when the UE device 500 is at a location where such a connection is possible.

Memory 512 includes an assembly of components 514, e.g., an assembly of software components, and data/information 516. In some embodiments, the assembly of software components 514 includes a connection manager component 574. Data/information 516 includes service provider 1 subscription information 517, e.g., credentials corresponding to service provide 1, service provider 2 subscription information 518, e.g., credentials corresponding to service provider 2. Data/information 516 includes UE location information 519, e.g., GPS coordinates and/or cell and sector information. Data/information 516 also includes criteria for generating and/or reporting UE location and measured signal information 520 (e.g., RSRP and RSRQ measured values). Data/information 516 further includes UE context information 521, e.g., UE identification information such as GUTI-1 assigned by a first wireless network, GUTI-2 assigned by a second wireless network, IMSI, IMEI, C-RNTI. Data/information 516 further includes session information 522 (e.g., session identification information (e.g., PDN ID, EPS bearer ID, LBI and TEID) for active sessions. Data/information 516 further includes measured signal information 523 such as for example RSRP and RSRQ measured values. Data/information 516 in some embodiments includes geo-fencing information 524 which includes location information (e.g., GPS coordinates) establishing a perimeter around the boundary of the coverage area for the first and/or second wireless networks. Data/information 516 includes handoff information 525 (e.g., information that a communications session has been successfully handed off, transferred or migrated from one network to another network). In some embodiments, such as those wherein the UE generates UE snapshots, the data/information 516 includes generated UE snapshots.

In some embodiments, the user equipment devices discussed in the Figures and/or in connection with the embodiments of the present invention described are implemented in accordance with user equipment device 500. For example user equipment devices UE 108, 110, 112, 114, 116, . . . , 118 of system 100, user equipment devices UE 1 206, . . . , UE N 207 of system 200, and user equipment device UE 404 of FIG. 4 and UE 1310 of FIG. 13 may be, and in some embodiments are, implemented in accordance with user equipment device 500.

FIG. 6 is a drawing of an exemplary communications equipment device, e.g., network equipment device, correlator, cloud connection manager, UE snapshot manager, OSS device, Mobility Management Entity (MME), Home Subscriber Server (HSS) in accordance with an exemplary embodiment. The communications equipment device 600 includes a plurality of network interfaces 605, . . . , 690, e.g., a wired or optical interface, a processor(s) 606 (e.g., one or more processors), e.g., a CPU, an assembly of hardware components 608, e.g., an assembly of circuits, and I/O interface 610 and memory 612 coupled together via a bus 609 over which the various elements may interchange data and information. The communications equipment device 600 further includes a speaker 652, a display 654, switches 656, keypad 658 and mouse 659 coupled to I/O interface 610, via which the various I/O devices (652, 654, 656, 658, 659) may communicate with other elements (605, . . . , 690, 606, 608, 612) of the communications equipment device 600. Network interface 605 includes a receiver 678 and a transmitter 680. The network interface 605 is typically used to communicate with other devices. In some embodiments, receiver 678 and transmitter 680 are part of a transceiver 684. Network interface 690 includes a receiver 694 and a transmitter 696. The network interface 690 is typically used to communicate with other devices, e.g., other network nodes in a core, etc. In some embodiments, receiver 694 and transmitter 696 are part of a transceiver 692. Memory 612 includes an assembly of component 614, e.g., an assembly of software components, and data/information 616. Data/information 616 includes information and data being stored at the communications equipment device e.g., UE profile and registration information 630 when the communications equipment device 600 is an HSS: UE snapshot records 632 when the communications equipment device 600 is implemented as UE snapshot manager, cloud connection manager, or correlator: OSS data/information 634, modified OSS data/information 636, KPIs 638 (e.g., counts of session drops, session drop records) when the communications device 600 is implemented as a correlator or OSS device: UE GUTI information (e.g., GUTI UE assignments) when the communications device 600 is a MME. 640.

In some embodiments, the communications equipment devices discussed in the Figures and/or in connection with the embodiments of the present invention described are implemented in accordance with communications equipment device 600. For example, communications equipment devices in the network cores 218 and 238, correlator 210, cloud connection manager 208 shown in system 200, cloud connection manager 408, correlator 410, entities in first network 1312, second network 1314, cloud connection manager 1316, correlator 1318, correlator 1506 shown in FIGS. 4, 13, and 14.

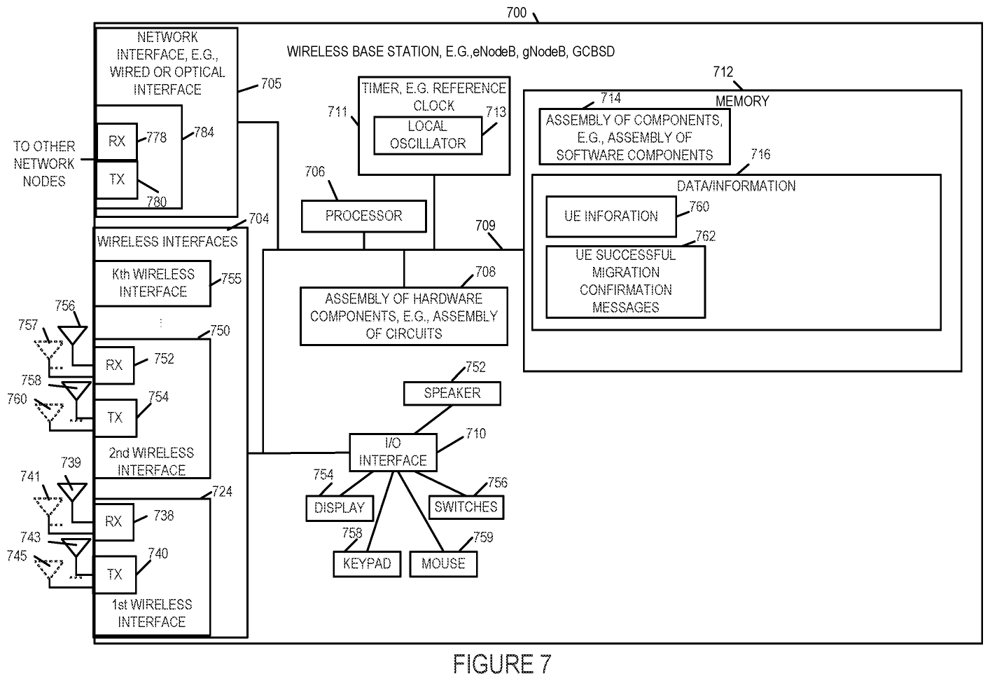

FIG. 7 is a drawing of an exemplary wireless base station 700 in accordance with an exemplary embodiment. FIG. 7 is a drawing of an exemplary wireless base station 700, e.g., an eNodeB, a gNodeB, or Citizens Broadband Radio Service wireless base station (CBSD), in accordance with an exemplary embodiment. Exemplary wireless base station 700 includes a wireless interface 704, a network interface 705, e.g., a wired or optical interface, a processor 706, e.g., a CPU, an assembly of hardware components 708, e.g., an assembly of circuits, and I/O interface 710, timer, e.g., reference clock 711 including a local oscillator 713, and memory 712 coupled together via a bus 709 over which the various elements may interchange data and information. Wireless base station 700 further includes a speaker 752, a display 754, switches 756, keypad 758 and mouse 759 coupled to I/O interface 710, via which the various I/O devices (752, 754, 756, 758, 759) may communicate with other elements (704, 705, 706, 708, 711, 712) of the wireless base station 700. Network interface 705 includes a receiver 778 and a transmitter 780. In some embodiments, receiver 778 and transmitter 780 are part of a transceiver 784. Wireless interfaces 704 include a plurality of wireless interfaces including first wireless interface 724, second wireless interface 750, . . . . Kth wireless interface 755. The wireless interfaces are used to communicate with the wireless devices, e.g., user equipment device, e.g., dual SIM dual subscriber (DSDS) user equipment devices. The first wireless interface 724 is used for example to communicate with a first user equipment device using a first spectrum band. The second wireless interface can be used to communicate with a second user equipment device using a second spectrum band. The first wireless interface 724 includes wireless receiver 738 and a wireless transmitter 740. In some embodiments, receiver 738 and transmitter 740 are part of a transceiver. In various embodiments, the first wireless interface 724 includes a plurality of wireless receivers and a plurality of wireless transmitters. Wireless receiver 738 is coupled to a plurality of receive antennas (receive antenna 1 739, . . . , receive antenna M 741), via which wireless base station 700 can receive wireless signals from other wireless communications devices including a second wireless communications device, e.g., a user equipment device. Wireless transmitter 740 is coupled to a plurality of wireless transmit antennas (transmit antenna 1 743, . . . , transmit antenna N 745) via which the wireless base station 700 can transmit signals to other wireless communications devices including a second wireless communications device, e.g., a user equipment device.

The second wireless interface 750 includes wireless receiver 752 and a wireless transmitter 754. In some embodiments, receiver 752 and transmitter 754 are part of a transceiver. In various embodiments, the second wireless interface 750 includes a plurality of wireless receivers and a plurality of wireless transmitters. Wireless receiver 752 is coupled to one or more receive antennas (receive antenna 1 756, . . . , receive antenna M 757), via which wireless base station 700 can receive wireless signals from other wireless communications devices including a second wireless communications device, e.g., DSDS UE device, using the same or a different wireless protocol than the first wireless interface. Wireless transmitter 754 is coupled to one or more wireless transmit antennas (transmit antenna 1 758, . . . , transmit antenna N 760) via which the wireless base station 400 can transmit signals to other wireless communications devices including a second wireless communications device. The wireless base station network interface 705 may be coupled to a cable modem, a core network, other networks, e.g., internet, or other wireless base stations.

Memory 712 includes an assembly of components 714, e.g., an assembly of software components, and data/information 716. Data/information 716 includes UE information 760 and UE successful migration confirmation messages 762. The UE confirmation messages 762 are messages which it receives from UEs that have successfully migrated session(s) to other wireless networks. The base station passes these messages on its network core for transmission to the cloud connection manager. The UE information 760 includes information on which UEs the base station is server and their reported state information, UE location information and signal measurements which the base station sends to its network core.

While the details of the first and second wireless interfaces are shown, the other wireless interfaces of the wireless base station, e.g., wireless interface K where K is an integer greater than 2 also include multiple receivers and transmitters so that the wireless base station 700 can provide wireless services to for example a plurality of wireless devices such as user equipment devices. In some embodiments, one or more of the wireless base stations discussed and/or shown in the Figures and/or in connection with the methods discussed herein are implemented in accordance with the wireless base station 700. For example, the wireless base stations shown and/or discussed in connection with system 100 of FIG. 1 (e.g., wireless base station 102, 104, and 106 of the large cell network and the wireless base stations not shown of the small cell network), the wireless base stations 214, 216, 234, 236 of FIG. 2 may be, and in some embodiments are, implemented in accordance with the wireless base station 700.

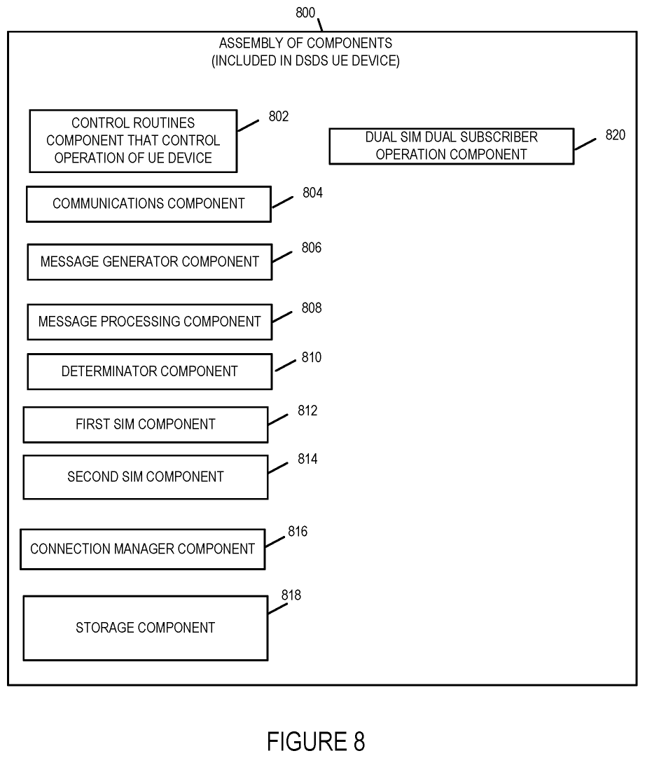

FIG. 8 is a drawing of an exemplary assembly of components 800 which may be included in an exemplary user equipment (UE) device, e.g., UE device 500 of FIG. 5, in accordance with an exemplary embodiment. The components in the assembly of components 800 can, and in some embodiments are, implemented fully in hardware within a processor, e.g., processor 506, e.g., as individual circuits. The components in the assembly of components 800 can, and in some embodiments are, implemented fully in hardware within the assembly of hardware components 508, e.g., as individual circuits corresponding to the different components. In other embodiments some of the components are implemented, e.g., as circuits, within processor 506 with other components being implemented, e.g., as circuits within assembly of components 508, external to and coupled to the processor 506. As should be appreciated the level of integration of components on the processor and/or with some components being external to the processor may be one of design choice. Alternatively, rather than being implemented as circuits, all or some of the components may be implemented in software and stored in the memory 512 of the UE device 500, with the components controlling operation of UE device 500 to implement the functions corresponding to the components when the components are executed by a processor e.g., processor 506. In some such embodiments, the assembly of components 800 is included in the memory 512 as assembly of software components 514. In still other embodiments, various components in assembly of components 800 are implemented as a combination of hardware and software, e.g., with another circuit external to the processor providing input to the processor which then under software control operates to perform a portion of a component's function. When implemented in software the components include code, which when executed by a processor, e.g., processor 506, configure the processor to implement the function corresponding to the component. In embodiments where the assembly of components 800 is stored in the memory 512, the memory 512 is a computer program product comprising a computer readable medium comprising code, e.g., individual code for each component, for causing at least one computer, e.g., processor 506, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 8 control and/or configure the UE device 500 or elements therein such as the processor 506, to perform the functions of corresponding steps illustrated and/or described in the method of one or more of the flowcharts, signaling diagrams and/or described with respect to any of the Figures. Thus the assembly of components 800 includes various components that perform functions of corresponding one or more described and/or illustrated steps of an exemplary method.

Assembly of components 800 includes a control routines component 802, a communications component 804, a message generator component 806, a message processing component 808, a determinator component 810, a first SIM component 812, a second SIM component 814, a connection manager component 816, a storage component 818 and a dual SIM dual subscriber mode of operation component 820.

The control routines component 802 is configured to control operation of the UE.

The communications component 804 is configured to handle communications, e.g., receipt and transmission of signals and provide protocol signal processing for one or protocols for the UE.

The message generator component 806 is configured to generate messages for transmission to wireless base stations (e.g., CBSD devices, eNodeBs, gNodeBs) such as messages including UE confirmation of successful migration messages, UE location and signal measurement reporting messages, etc. In some embodiments, the message generator component 806 is a sub-component of the communications component 804.

The message processing component 808 processes received messages, e.g., requests for information. In some embodiments, the message processing component 808 is a sub-component of the communications component 804.

The determinator component 810 makes determination for the user equipment devices such as for example, whether or not to measure signals, determine UE location, report UE state information, context information, signal measurements.

The first SIM component 812 is configured to store Subscriber Identity Information, e.g., a first set of credentials, for obtaining access to a first service provider/operator's wireless network.

The second SIM component 814 is configured to store Subscriber Identity Information, e.g., a second set of credentials, for obtaining access to a second service provider/operator's wireless network.

The connection manager component 816 is configured to manage the communications between the user equipment device and a first network and a second network including coordinating the off-load and/or handoff of communications sessions from one network to the other network and the generation and sharing of information between wireless base stations of different networks, the generating and reporting of UE location information, UE signal measurements, UE confirmation messages of successful migrations between networks.

The storage component 818 is configured to perform all operations in storing and retrieving information, e.g., UE state information, UE context information, UE location information, UE signal measurements, geo-fencing coordinates/information for one or more wireless networks coverage area (e.g., first wireless network coverage area and second wireless network coverage area, from memory and/or storage devices (e.g., SIMs) located in the user equipment device.

The dual SIM dual subscriber mode of operation component 820 is configured to implement all operations for operating as a dual subscriber in which the user equipment device utilizes both SIM cards to communicate with two different wireless base stations using two different subscriptions, e.g., simultaneously or switching back forth between the two different wireless base stations. This component includes the management of the signaling between the two wireless base stations. In some embodiments, the dual SIM dual subscriber mode of operation component is a sub-component of the communications component 804.

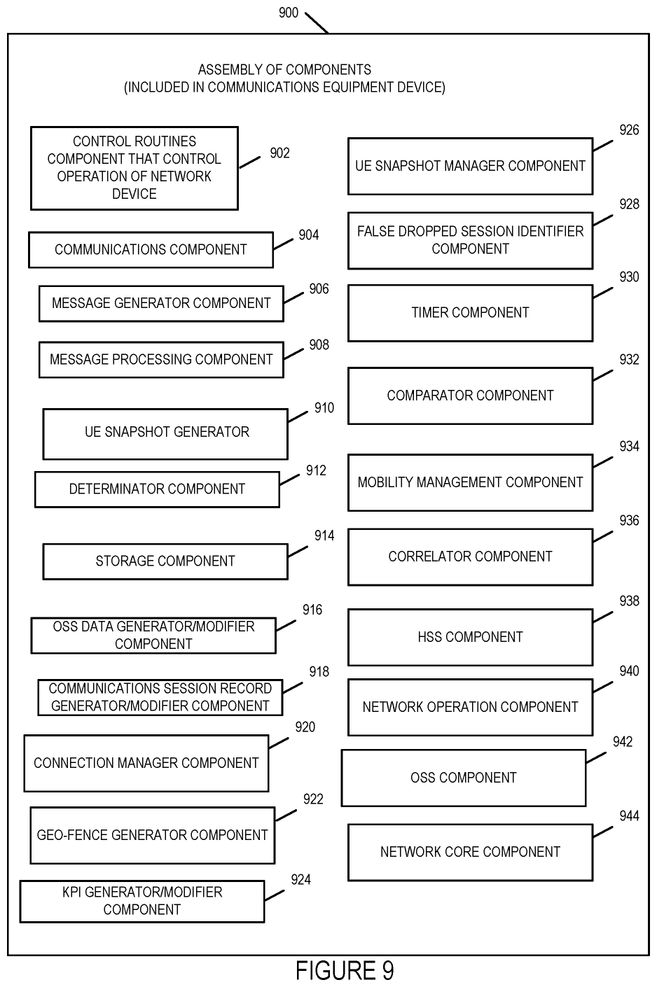

FIG. 9 is a drawing of an exemplary assembly of components 900 which may be included in a network equipment device 600 of FIG. 6, in accordance with an exemplary embodiment. The components in the assembly of components 900 can, and in some embodiments are, implemented fully in hardware within a processor or one or more processors, e.g., processor(s) 606, e.g., as individual circuits. The components in the assembly of components 900 can, and in some embodiments are, implemented fully in hardware within the assembly of hardware components 608, e.g., as individual circuits corresponding to the different components. In other embodiments some of the components are implemented, e.g., as circuits, within processor(s) 606 with other components being implemented, e.g., as circuits within assembly of components 608, external to and coupled to the processor(s) 606. As should be appreciated the level of integration of components on the processor and/or with some components being external to the processor may be one of design choice. Alternatively, rather than being implemented as circuits, all or some of the components may be implemented in software and stored in the memory 612 of the communications equipment device 600, with the components controlling operation of the communications equipment device 600 to implement the functions corresponding to the components when the components are executed by a processor e.g., processor 606. In some such embodiments, the assembly of components 900 is included in the memory 612 as assembly of software components 614. In still other embodiments, various components in assembly of components 900 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 606, configure the processor(s) to implement the function corresponding to the component. In embodiments where the assembly of components 900 is stored in the memory 612, the memory 612 is a computer program product comprising a computer readable medium comprising code, e.g., individual code for each component, for causing at least one computer, e.g., processor 606, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 9 control and/or configure the communications equipment device 600 or elements therein such as the processor(s) 606, to perform the functions of corresponding steps illustrated and/or described in the method of one or more of the flowcharts, signaling diagrams and/or described with respect to any of the Figures. Thus the assembly of components 900 includes various components that perform functions of corresponding one or more described and/or illustrated steps of an exemplary method.

Assembly of components 900 includes a control routines component 902, a communications component 904, a message generator component 906, a message processing component 908, an UE snapshot generator component 910, a determinator component 912, a storage component 914, an OSS data generator/modifier component 916, a communications session record generator/modifier component 918, a connection manager component 920, a geo-fence generator component 922, a KPI generator/modifier component 924, a UE snapshot manager component 924, a false dropped session identifier component 928, a timer component 930, a comparator component 932, a mobility management component 934, a correlator component 936, a HSS component 938, a network operation component 940, OSS component 942, and a network core component 944.

The control routines component 902 is configured to control operation of the communications equipment device.

The communication component 904 is configured to handle communications, e.g., transmission and reception of messages, and protocol signaling for the communications equipment device.

The message generator component 906 is configured to generate messages for transmission to other devices. Exemplary messages which are generated include UE snapshot messages, OSS data message, UE successful migration confirmation message.

The message processing component 908 is configured to process messages and implement procedures/operations in response to messages or based on the contents of messages. This includes messages received from other devices, e.g., messages from wireless base stations, notification messages, messages with instructions.

The UE snapshot generator component 910 is configured to generate UE snapshot records using UE reported information (e.g., UE location and/or signaling measurements) and/or network core information (e.g., UE profile, registration and mobility and connection information). In some embodiments the UE snapshot generator component 910 is a sub-component of the UE snapshot manager 926 or OSS component 942.

The determinator component 912 is configured to make determinations and decisions for the communications equipment device including for example: determining and/or identifying one or more false session drops in the first OSS data using a plurality of user equipment snapshot data records and the a first plurality of session data records: determining to generate a first user equipment snapshot data record based on one or more of the following: location information received a user equipment device or signaling information received from the user equipment device: determining when a first criteria is met, determining when a first set of conditions is met, determining which UE snapshot records are to be deleted, determining when a period of time has expired, determining whether or not a UE snapshot record corresponds to a successful migration, determining what automated network operation to perform based on modified OSS data/information received from a correlator, determining whether a session is a false dropped session, determining whether a communications session record is to modified because it is a false dropped session record, determining whether to mark or delete OSS data records corresponding to false session drops, and determining KPIs using modified session drop information, determining whether a UE confirmation message of a successful migration has been received whether a first time period.

The storage component 914 is configured to manage the storage, and retrieval of data and/or instructions to/and from memory, and/or storage devices coupled and/or connected to the communications equipment device, e.g., storage of a UE snapshot records, OSS data/information, modified OSS data/information, UE profile and registration information, UE location information, session records, KPIs, allocation of resource spectrum, location of UE devices (e.g., by geographical coordinates, cells and/or cell sector), geo-fence coordinates, UE signal measurements, UE context information, UE subscriber information, UE identification information, session identification information.

The OSS data generator/modifier component 916 is configured to generate and/or modify OSS data for example to generate communications session records, session drop records, and KPI data and/or records. In some embodiments, the OSS data generator/modifier component 916 is a sub-component of the OSS component 942 and/or the correlator component 936. The OSS data/modifier component 916 in some embodiments, modifies data and/or records to correct for identified false session drops.

The communications session record generator/modifier component 918 is configured to generator and/or modifier communications session records. An exemplary communications session record is described in FIG. 15. In some embodiments, the communications session record generator/modifier is a sub-component of the correlator component 936 or the OSS component 942. In some embodiments, the communications session record generator/modifier component modifies communications session records which have been identified as false session drops so that the reason for the session termination reflects that the session was successfully transferred. In some embodiments, the communications session record generator/modifier deletes communications session records which have been incorrectly included in a set of communications session drop records when the record has been identified corresponding to a false session drop.

The connection manager component 920 is configured to perform the operations, steps and/or functions described as being performed by or at a cloud connection manager herein such as for example receiving UE snapshot records, UE successful confirmation messages, and determine which UE snapshot records correspond to successful migrations and which do not, communicate or transmit UE snapshot records which are determined to correspond to successful migrations to the correlator.

The geo-fence generator component 922 is a component that generates a geo-fence around the perimeter of the coverage area of wireless network. In some embodiments, the geo-fence generator component 922 also provides the geographical coordinates of the geo-fence to user equipment devices, network core OSS devices and/or components, and/or UE snapshot manager devices and/or components.

The KPI generator/modifier component 924 is configured to generate and/or modify KPIs such as for example those KPIs discussed above in connection with FIG. 12 (e.g., session drop counts, session drop records, etc.) In various embodiments, the KPI generator/modifier is a sub-component of the OSS component 942 and/or the correlator component 936.

The UE snapshot manager component 924 is configured to perform the steps, operations and functions discussed in connection with the various Figures, systems and methods described as being performed by or at the UE snapshot manager including for example receiving UE location and signaling measurements from UEs via base stations, determining whether or not a UE snapshot is to be generated based on received UE information, generating a UE snapshot (e.g., UE snapshot record 1110), transmitting the UE snapshot to the cloud connection manager, receiving successful migration confirmation messages and communicating them to the cloud connection manager.

The false dropped session identifier component 928 is configured to identify sessions which labeled as dropped but were in fact successfully migrated to another wireless network. In some embodiments, the false dropped session identifier compares UE snapshot records corresponding to successful migrations to session records to identify the false dropped sessions. In some embodiments, the false dropped session identifier component 926 is further configured to mark or delete false dropped session records. In some embodiments, false dropped session identifier component 928 is a sub-component of the correlator component 936.

The timer component 930 is configured to track periods of time such as for example a period of time during which UE snapshot records are to be stored at a cloud connection manager before being deleted, a period of time to accumulate UE snapshot records corresponding to successful migration before transmitting accumulated UE snapshot records to a correlator for processing.

A comparator component 932 is configured to compare data, information and/or records to determine if there is a match.

A mobility management component 934 is configured to perform mobility management functions such as for example assigning GUTI identifiers to UE devices and providing UE connectivity to entities, e.g., UE snapshot manager, that are generating UE snapshots.

The correlator component 936 is configured to perform the steps, operations, and/or functions described as being performed by or at correlator devices in the systems, methods and Figures of this specification including receiving OSS data, receiving UE snapshot records corresponding to successful migrations, identifying and/or determining which session drops are false session drops based on the received UE snapshot records and OSS data, modifying OSS data by marking or deleting the false dropped session from the OSS data, and transmitting the modified OSS data to the OSS of a core network. In some embodiments, the correlator component 936 generates and/or modifies KPIs such as the false dropped session records and/or session drop counts.

The HSS component 938 is configured to store UE profile and registration information.

The network operation component 940 is configured to automatically perform one or more network operations based on modified OSS data. In some embodiments, the network operation component 940 is configured to automatically assign or allocate resources and/or modify resource allocations (e.g., change transmission power levels or allocation of spectrum) to wireless base stations and/or user equipment devices, e.g., based on modified OSS data, modified KPIs generated and/or KPIs generated from modified OSS data such as KPIs which take into account sessions which have been successfully migrated as opposed to being dropped (i.e., false dropped sessions). In some embodiments, the network operation component 940 automatically changes network configurations such as which types of sessions are to be offloaded to other networks based on modified OSS data which takes into account false dropped sessions. In some embodiments, the network operation component is a sub-component of the OSS component 942.

The OSS component 942 is configured to perform the steps, functions and/or operations described as being performed by or at an OSS in the systems, embodiments, Figures and methods as discussed herein including the generation of OSS data, session data records, dropped session data records, transmission of OSS data/information, receipt of modified OSS data/information, performing automated network operations based on modified OSS data/information. In some embodiments, the OSS components also generates UE snapshot records and transmits them to the cloud connection manager.

The network core component 944 is configured to perform the steps, functions and/or operations described as being performed by or at a network core in the systems, embodiments, Figures and methods as discussed herein.

The specific components of the assembly of components 900 included in any particular communications equipment device may, and typically does vary depending on the specific communications equipment device and the functionality required for the device and/or the operations the communications equipment device is responsible for performing.

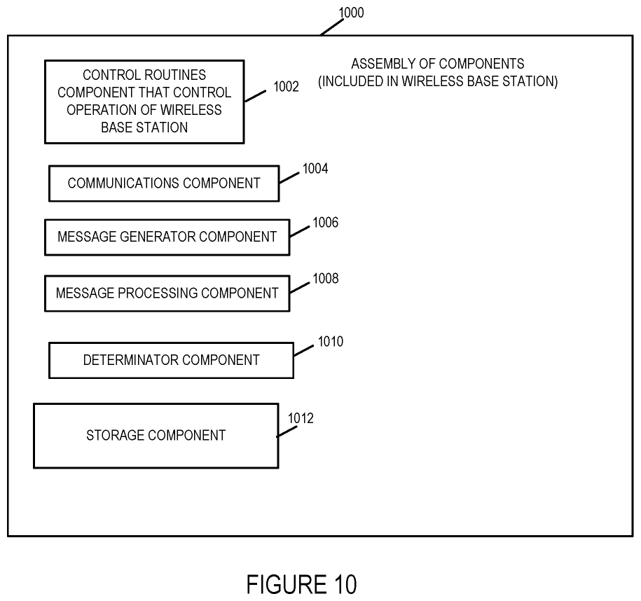

FIG. 10 is a drawing of an exemplary assembly of components 1000 which may be included in an exemplary wireless base station (e.g., exemplary wireless base station 700 of FIG. 7), in accordance with an exemplary embodiment. The components in the assembly of components 1000 can, and in some embodiments are, implemented fully in hardware within a processor, e.g., processor 706, e.g., as individual circuits. The components in the assembly of components 1000 can, and in some embodiments are, implemented fully in hardware within the assembly of hardware components 708, e.g., as individual circuits corresponding to the different components. In other embodiments some of the components are implemented, e.g., as circuits, within processor 706 with other components being implemented, e.g., as circuits within assembly of components 708, external to and coupled to the processor 706. As should be appreciated the level of integration of components on the processor and/or with some components being external to the processor may be one of design choice. Alternatively, rather than being implemented as circuits, all or some of the components may be implemented in software and stored in the memory 712 of the wireless base station 700, with the components controlling operation of wireless base station device 700 to implement the functions corresponding to the components when the components are executed by a processor e.g., processor 706. In some such embodiments, the assembly of components 1000 is included in the memory 712 as assembly of software components 714. In still other embodiments, various components in assembly of components 1000 are implemented as a combination of hardware and software, e.g., with another circuit external to the processor providing input to the processor which then under software control operates to perform a portion of a component's function.

When implemented in software the components include code, which when executed by a processor, e.g., processor 706, configure the processor to implement the function corresponding to the component. In embodiments where the assembly of components 1000 is stored in the memory 712, the memory 712 is a computer program product comprising a computer readable medium comprising code, e.g., individual code for each component, for causing at least one computer, e.g., processor 706, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 7 control and/or configure the wireless base station 700 or elements therein such as the processor 406, to perform the functions of corresponding steps illustrated and/or described in the method of one or more of the flowcharts, signaling diagrams and/or described with respect to any of the Figures. Thus the assembly of components 1000 includes various components that perform functions of corresponding one or more described and/or illustrated steps of an exemplary method.

Assembly of components 1000 includes a control routines component 1002, a communications component 1004, a message generator component 1006, a message processing component 1008, a determinator component 1010, and a storage component 1012.

The control routines component 1002 is configured to control operation of the wireless base station (e.g., eNodeB, gNodeB, CBSD, etc.).

The communication component 1004 is configured to handle communications, e.g., transmission and reception of messages, and protocol signaling for the wireless base station.

The message generator component 1006 is configured to generate messages for transmission to other devices, e.g., request messages, response messages, notification messages, messages for sharing information, communications messages with network equipment devices, communications messages with user equipment devices. In some embodiments, the message generator component 1006 is a sub-component of the communications component 1004.

The message processing component 1008 is configured to process messages received from other devices and implement operations in response to instructions and/or information included in the processed message, e.g., processing and implementing operations in connection with messages from user equipment devices, messages from network equipment devices. In some embodiments, the message processing component 1008 is a sub-component of the communications component 1004.

The determinator component 1010 is configured to make determinations and decisions for the wireless base station including for example: determining when to send information and/or messages to a network equipment device in a core network in response to receiving information and/or messages from a user equipment device (e.g., UE location and/or signaling measurement messages, UE successful hand off/transfer/migration messages), determine when to communicate UE state information or a UE snapshot provided by a UE to core network equipment.

The storage component 1012 is configured to manage the storage, and retrieval of data and/or instructions to/and from memory, buffers in memory, hardware buffers and/or storage device coupled and/or connected to the wireless base station.

Various exemplary numbered embodiments illustrating different features of the present invention will now be discussed. The various features discussed may be used in variety of different combinations. The numbered embodiments are only exemplary and are not meant to be limiting to the scope of the invention. The various method embodiments may be, and in some embodiments are, implemented on system 200 of FIG. 2.

### List of Exemplary Numbered Method Embodiments

Method Embodiment 1. A communications method comprising: receiving at a correlator from a cloud connection manager a plurality of user equipment snapshot data records corresponding to successful user equipment device migrations from a first wireless network to a second wireless network, each of said user equipment snapshot data records including a timestamp, user equipment device identification information, session identification information, and location information: receiving, by the correlator, from a first network core of a Hybrid Mobile Network Operator (HMNO) wireless system first Operations Support System (OSS) data, said first OSS data including a first plurality of session data records: identifying one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicating, by the correlator, the modified first OSS data to the first network core of the HMNO wireless system.

Method Embodiment 1A. The method of Method Embodiment 1, wherein the first wireless network and second wireless network are operated independently by two different operators.

Method Embodiment 1A1. The communications method of Method Embodiment 1A, wherein the first wireless network is a Mobile Virtual Network Operator network operated by a first operator (e.g., Verizon) for a second operator (e.g., Charter): wherein the second wireless network is a Multiple System Operator (MSO) network operated by the second operator: and wherein the first wireless network and the second wireless network are operated independently.

Method Embodiment 1A2. The communications method of Method Embodiment 1, further comprising: successfully migrating a plurality of user equipment devices from the first wireless network to the second wireless network, said plurality of user equipment devices being Dual Subscriber Identity Module (SIM) Dual Subscriber (DSDS) user equipment devices with a first SIM and a first subscription for operating on the first wireless network and a second SIM and a second subscription for operating on the second wireless network.

Method Embodiment 1A3. The communications method of Method Embodiment 1A2, wherein successfully migrating a plurality of Dual Subscriber Identity Module (SIM) Dual Subscriber (DSDS) user equipment devices from the first wireless network to the second wireless network includes handing off or transferring active communications sessions for which a first wireless base station in the first wireless network is providing services to a second wireless base station in the second wireless network without dropping the communications session.

Method Embodiment 1A4. The communications method of Method Embodiment 1, wherein user equipment devices of the Hybrid Mobile Network Operator (HMNO) wireless system are Dual Subscriber Identity Module (SIM) Dual Subscriber (DSDS) user equipment devices with a first SIM and a first subscription allowing operation on the first wireless network and a second SIM and a second subscription allowing operation on the second wireless network, each of said DSDS user equipment devices including a connection manager coordinating transfers of the user equipment device communications sessions between the first wireless network and the second wireless network (e.g., transfers or handoffs from the first wireless network to the second wireless network and transfers or handoffs from the second wireless network to the first wireless network).

Method Embodiment 1A5. The communications method of Method Embodiment 1A, wherein the first wireless network is a Multiple System Operator (MSO) network operated by a first operator (e.g., Charter): wherein the second wireless network is a Mobile Virtual Network Operator network operated by a second operator (e.g., Verizon) for the first operator (e.g., Charter); and wherein the first wireless network and the second wireless network are operated independently.

Method Embodiment 1B. The communications method of Method Embodiment 1, wherein the first wireless network is a large cell wireless network and the second wireless network is a small cell wireless network: and wherein a plurality of the second wireless network cells are encompassed by cells of the first wireless network.

Method Embodiment 1C. The communications method of Method Embodiment 1, prior to receiving at the correlator from the cloud connection manager the plurality of user equipment snapshot data records corresponding to successful user equipment device migrations from the first wireless network to the second wireless network, determining by a first user equipment device a location of the first user equipment device with respect to a geofence surrounding the perimeter of the coverage area of first wireless network: generating a first user equipment snapshot data record at the first user equipment device: and transmitting the first user equipment snapshot data record from the first user equipment device to the cloud connection manager via the first wireless network and first core network.

Method Embodiment 2. The communications method of Method Embodiment 1 further comprising: prior to receiving at the correlator from the cloud connection manager the plurality of user equipment snapshot data records corresponding to successful user equipment device migrations from the first wireless network to the second wireless network, generating a first user equipment snapshot data record at the first network core based on information (e.g., UE location and/or signaling information) received from a first user equipment device connected to a first base station of the first wireless network at a first time, said first user equipment snapshot data record being one of the plurality of user equipment snapshot data records corresponding to successful user equipment device migrations from the first wireless network to the second wireless network: and transmitting the first user equipment snapshot data record from the first network core to the cloud connection manager.

Method Embodiment 2A1. The communications method of Method Embodiment 2, wherein the first user equipment snapshot data record is also generated based on first user equipment device profile information included in a first Home Subscriber Server (HSS) of the first network core.

Method Embodiment 2A2. The communications method of Method Embodiment 2A1, wherein the first user equipment snapshot data record is also generated based on first user equipment device registration information included in the first Home Subscriber Server (HSS) of the first network core.

Method Embodiment 2A3. The communications method of Method Embodiment 2A1, wherein the first user equipment snapshot data record is also generated based on first user equipment device connectivity information (e.g., session information, GUTI assigned by the MME or AMF to the first user equipment device) maintained in the first network core (e.g., in the Mobility Management Entity (MME) or Access and Mobility Function (AMF) of the first network core).

Method Embodiment 3. The communications method of Method Embodiment 2, further comprising: prior to generating the first user equipment snapshot data record at the first network core based on information (e.g., UE location and/or signaling information) received from the first user equipment device connected to the first base station of the first wireless network at the first time, determining at the first network core to generate the first user equipment snapshot data record based on one or more of the following: location information received from the first user equipment device or signaling information received from the first user equipment device.

Method Embodiment 4. The communications method of Method Embodiment 3, wherein determining at the first network core to generate the first user equipment snapshot data record based on one or more of the following: location information received from the first user equipment device or signaling information received from the first user equipment device includes: determining to generate the first user equipment snapshot data record when a first criteria is met.

Method Embodiment 5. The communications method of Method Embodiment 4, wherein the first criteria is met when at least one of the following is true: the location information received from the first user equipment device indicates the first user equipment device is within a first distance (e.g., 10 feet) of a perimeter of the wireless coverage area of the second wireless network (e.g., a location indicating that the first user equipment device is about to enter the coverage of the second wireless network) or the signaling information (e.g., UE measured RSRP or RSRQ) received from the first user equipment device is below a first threshold level (e.g., a threshold level indicating that the first user equipment device is on the verge of being migrated to the second wireless network from the first wireless network).

Method Embodiment 6. The communications method of Method Embodiment 1, further comprising: prior to receiving at the correlator from the cloud connection manager a plurality of user equipment snapshot data records corresponding to successful user equipment device migrations from a first wireless network to a second wireless network, receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network: determining, at the cloud connection manager, which of the user equipment snapshot data records received from the first network core correspond to a successful user equipment device migration from the first wireless network to the second wireless network: and transmitting the plurality of user equipment snapshot data records corresponding to successful user equipment device migrations from the first wireless network to the second wireless network.

Method Embodiment 7. The communications method of Method Embodiment 6, wherein said determining, at the cloud connection manager, which of the user equipment snapshot data records received from the first network core correspond to a successful user equipment device migration from the first wireless network to the second wireless network includes: determining a first user equipment snapshot data record for a first user equipment device corresponds to a successful first user equipment device migration from the first wireless network to the second wireless network when a first confirmation message indicating a successful migration from the first wireless network to the second wireless network has been completed is received at the cloud connection manager from the first user equipment device in a first period of time (e.g., 5 minutes after receipt of the first user equipment snapshot data record from the first network core).

Method Embodiment 7A. The communications method of Method Embodiment 7, wherein said determining, at the cloud connection manager, which of the user equipment snapshot data records received from the first network core correspond to a successful user equipment device migration from the first wireless network to the second wireless network further includes: determining a first user equipment snapshot data record for a first user equipment device does not correspond to a successful first user equipment device migration from the first wireless network to the second wireless network when a first confirmation message indicating a successful migration from the first wireless network to the second wireless network has been completed is not received at the cloud connection manager from the first user equipment device in the first period of time.

Method Embodiment 8. The communications method of Method Embodiment 1, further comprising: receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network: receiving, at the connection manager, from each user equipment device which has successfully migrated from the first wireless network to the second wireless network a confirmation message indicating the completion of the successful migration of the user equipment device, said confirmation message including information (e.g., user equipment device identification information such as GUTI information and/or session identification information) from which corresponding user equipment snapshot data records can be identified: and identifying, at the cloud connection manager, which of the user equipment snapshot data records received from the first network core correspond to successful migrations of user equipment devices from the first wireless network to the second wireless network using information included in the received confirmation messages and a time when the confirmation message was received at the cloud connection manager.

Method Embodiment 9. The communications method of Method Embodiment 8, wherein the confirmation messages are received, at the cloud connection manager, from the user equipment devices via the second wireless network.

Method Embodiment 9A. The communications method of Method Embodiment 8, wherein the confirmation messages are generated by connection manager applications executing on the user equipment devices which have been successfully migrated from the first wireless network to the second wireless network.

Method Embodiment 10. The communications method of Method Embodiment 1, further comprising: receiving at the first network core the first modified OSS data: and performing automated network operations at the first core network based on the first modified OSS data.

Method Embodiment 10A. The communications method of Method Embodiment 10, wherein said automated network operations at the first core network include one or more of the following: (i) re-allocation of network resources (e.g., modifying spectrum allocations and/or transmit power allocations (e.g., increase transmit power) to one or more wireless base stations in the first wireless network based on actual session drops identified in the modified OSS data occurring in cells of the first wireless network, or (ii) modifying which types of communications sessions are to be migrated from the first wireless network to the second wireless network (e.g., changing the first wireless networks configuration to no longer off-load data sessions of a specific type (e.g., Youtube sessions from a specific IP address, real-time data sessions, or data sessions with a specific quality of service requirement)) from the first wireless network to the second wireless network.

Method Embodiment 11. The communications method of Method Embodiment 1, wherein session drops are a key performance indicator used for monitoring network performance of the first wireless network: and wherein the communications method further includes: implementing, by an Operations Service System of the first network core an automated network operation (e.g., change in first wireless network configuration, change in transmission power level or change in spectrum assignments for one or more base stations in the first wireless network) to optimize performance of the first wireless network based on the modified session drop information included in the modified first OSS data.

Method Embodiment 11A. The communications method of Method Embodiment 1, wherein said first OSS data includes key performance indicators used for monitoring the performance of the first wireless network: wherein said modified first OSS data includes modified key performance indicators used for monitoring the performance of the first network: and wherein said modified key performance indicators include number of sessions dropped by a base station within a time period, number of sessions dropped in each cell within a time period, number of session dropped in a cell sector within a time period, data throughput for each cell within a time period, data throughput for each cell sector within a time period, far end server IP addresses with session drops above a first threshold level value, number of session drops by cell and session type over a period of time, number of session drops by cell sector and session type over a period of time.

Method Embodiment 12. The communications method of Method Embodiment 1, wherein said identifying one or more false session drops in the first OSS data using the plurality of user equipment snapshot data records and the first plurality of session data records includes: comparing information contained in the user equipment snapshot data records which correspond to a successful user equipment device migration to the session data records which include information on whether or not the session was dropped.

Method Embodiment 12A. The communications method of Method Embodiment 12, wherein the information contained in the user equipment snapshot data records includes user equipment device identifier information (e.g., Cell Radio Network Temporary Identifier (C-RNTI), Globally Unique Temporary ID (GUTI), International Mobile Subscriber Identity (IMSI), International Mobile Equipment Identity (IMEI) information), time information (e.g., timestamp), location information (e.g., physical location and/or first wireless network cell or cell sector location), and session identifier information (e.g., Packet Data Network (PDN) ID information, Evolved Packet System Bearer Identifier (EPS bearer ID) information, Linked EPS Bearer ID (LBI) information, and Tunnel End Point Identifier (TEID) information).

Method Embodiment 12B. The communications method of Method Embodiment 12A, wherein session data records include user equipment user equipment device identifier information (e.g., Cell Radio Network Temporary Identifier (C-RNTI), Globally Unique Temporary ID (GUTI), International Mobile Subscriber Identity (IMSI), International Mobile Equipment Identity (IMEI) information), time information indicating when the session was terminated, location information (e.g., physical location and/or first wireless network cell or cell sector location) for user equipment device endpoint of the session at time of session termination, session identifier information for the session (e.g., Packet Data Network (PDN) ID information, Evolved Packet System Bearer Identifier (EPS bearer ID) information, Linked EPS Bearer ID (LBI) information, and Tunnel End Point Identifier (TEID) information), information indicating how and/or why the session was terminated (e.g., session dropped by user equipment device).

Method Embodiment 13. A communications method comprising: receiving at a correlator from a cloud connection manager a plurality of user equipment snapshot data records corresponding to successful user equipment device migrations from a first wireless network to a second wireless network: receiving, by the correlator, from a first network core of a Hybrid Mobile Network Operator (HMNO) wireless system first Operations Support System (OSS) data, said first OSS data including a first plurality of session data records: identifying one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicating, by the correlator, the modified first OSS data to the first network core of the HMNO wireless system.

### List of Exemplary Numbered System Embodiments

System Embodiment 1. A communications system comprising: a correlator including: memory, and a first processor, said first processor controlling the correlator to perform the following operations: receive from a cloud connection manager a plurality of user equipment snapshot data records corresponding to successful user equipment device migrations from a first wireless network to a second wireless network, each of said user equipment snapshot data records including a timestamp, user equipment device identification information, session identification information, and location information: receive from a first network core of a Hybrid Mobile Network Operator (HMNO) wireless system first Operations Support System (OSS) data, said first OSS data including a first plurality of session data records: identify one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicate the modified first OSS data to the first network core of the HMNO wireless system.

System Embodiment 1A. The communications system of System Embodiment 1, wherein the first wireless network and second wireless network are operated independently by two different operators.

System Embodiment 1A1. The communications system of System Embodiment 1A, wherein the first wireless network is a Mobile Virtual Network Operator network operated by a first operator (e.g., Verizon) for a second operator (e.g., Charter): wherein the second wireless network is a Multiple System Operator (MSO) network operated by the second operator: and wherein the first wireless network and the second wireless network are operated independently.

System Embodiment 1A2. The communications system of System Embodiment 1, further comprising: a plurality of user equipment devices that are Dual Subscriber Identity Module (SIM) Dual Subscriber (DSDS) user equipment devices with a first SIM and a first subscription for operating on the first wireless network and a second SIM and a second subscription for operating on the second wireless network.

System Embodiment 1A3. The communications system of System Embodiment 1A2, wherein the plurality of user equipment devices each include memory, and a processor, said processor controlling the user equipment device in which it is located to transfer active communications sessions from the first wireless network to the second wireless network under a first set of conditions, said first set of conditions including one or more of the following: the location of the user equipment device being within the coverage area of the second wireless network, quality of reference signals (RSRP and/or RSRQ) received by the user equipment device from a base station of the second wireless network, strength of the reference signals (RSRP and/or RSRQ) received by the user equipment device from a base station of the second wireless network, or the type of communications session.

System Embodiment 1A4. The communications system of System Embodiment 1, wherein user equipment devices of the Hybrid Mobile Network Operator (HMNO) wireless system are Dual Subscriber Identity Module (SIM) Dual Subscriber (DSDS) user equipment devices with a first SIM and a first subscription allowing operation on the first wireless network and a second SIM and a second subscription allowing operation on the second wireless network, each of said DSDS user equipment devices including a connection manager coordinating transfers of the user equipment device communications sessions between the first wireless network and the second wireless network (e.g., transfers or handoffs from the first wireless network to the second wireless network and transfers or handoffs from the second wireless network to the first wireless network).

System Embodiment 1A5. The communications system of System Embodiment 1A, wherein the first wireless network is a Multiple System Operator (MSO) network operated by a first operator (e.g., Charter): wherein the second wireless network is a Mobile Virtual Network Operator network operated by a second operator (e.g., Verizon) for the first operator (e.g., Charter): and wherein the first wireless network and the second wireless network are operated independently.

System Embodiment 1B. The communications system of System Embodiment 1, wherein the first wireless network is a large cell wireless network and the second wireless network is a small cell wireless network: and wherein a plurality of the second wireless network cells are encompassed by cells of the first wireless network.

System Embodiment 1C. The communications system of System Embodiment 1, further comprising: a first user equipment device, said first user equipment device including memory and a processor, said processor controlling the first user equipment device to perform the following operations prior to the correlator receiving from the cloud connection manager the plurality of user equipment snapshot data records corresponding to successful user equipment device migrations from the first wireless network to the second wireless network: determine by the first user equipment device a location of the first user equipment device with respect to a geofence surrounding the perimeter of the coverage area of first wireless network: generate a first user equipment snapshot data record for the first user equipment device: and transmit the first user equipment snapshot data record from the first user equipment device to the cloud connection manager via the first wireless network and first core network.

System Embodiment 2. The communications system of System Embodiment 1, wherein prior to the correlator receiving from the cloud connection manager the plurality of user equipment snapshot data records corresponding to successful user equipment device migrations from the first wireless network to the second wireless network, an entity (e.g., a user equipment snapshot data manager or Operations Support System) in first network core performs the operations of: generating a first user equipment snapshot data record based on information (e.g., UE location and/or signaling information) received from a first user equipment device connected to a first base station of the first wireless network at a first time, said first user equipment snapshot data record being one of the plurality of user equipment snapshot data records corresponding to successful user equipment device migrations from the first wireless network to the second wireless network: and transmitting the first user equipment snapshot data record from the first network core to the cloud connection manager.

System Embodiment 2A1. The communications system of System Embodiment 2, wherein the first user equipment snapshot data record is also generated based on first user equipment device profile information included in a first Home Subscriber Server (HSS) of the first network core.

System Embodiment 2A2. The communications system of System Embodiment 2A1, wherein the first user equipment snapshot data record is also generated based on first user equipment device registration information included in the first Home Subscriber Server (HSS) of the first network core.

System Embodiment 2A3. The communications system of System Embodiment 2A1, wherein the first user equipment snapshot data record is also generated based on first user equipment device connectivity information (e.g., session information, GUTI assigned by the MME or AMF to the first user equipment device) maintained in the first network core (e.g., in the Mobility Management Entity (MME) or Access and Mobility Function (AMF) of the first network core).

System Embodiment 3. The communications system of System Embodiment 2, wherein prior to the first user equipment snapshot data record being generated, said entity in the first network core determining to generate the first user equipment snapshot data record based on one or more of the following: location information received from the first user equipment device or signaling information received from the first user equipment device.

System Embodiment 3A. The communications system of System Embodiment 3, wherein the entity in the first network core is a user equipment snapshot management device.

System Embodiment 4. The communications system of System Embodiment 3, wherein determining to generate the first user equipment snapshot data record based on one or more of the following: location information received from the first user equipment device or signaling information received from the first user equipment device includes: determining to generate the first user equipment snapshot data record when a first criteria is met.

System Embodiment 5. The communications system of System Embodiment 4, wherein the first criteria is met when at least one of the following is true: the location information received from the first user equipment device indicates the first user equipment device is within a first distance (e.g., 10 feet) of a perimeter of the wireless coverage area of the second wireless network (e.g., a location indicating that the first user equipment device is about to enter the coverage of the second wireless network) or the signaling information (e.g., UE measured RSRP or RSRQ) received from the first user equipment device is below a first threshold level (e.g., a threshold level indicating that the first user equipment device is on the verge of being migrated to the second wireless network from the first wireless network).

System Embodiment 6. The communications system of System Embodiment 1, wherein prior to receiving at the correlator from the cloud connection manager a plurality of user equipment snapshot data records corresponding to successful user equipment device migrations from a first wireless network to a second wireless network, the cloud connection is operated by a processor included in the cloud connection manager to perform the following operations: receive user equipment snapshot data records from the first network core, said user equipment snapshot data records received from the first network core including the plurality of user equipment snapshot data records corresponding to successful user equipment device migrations from the first wireless network to the second wireless network: determine which of the user equipment snapshot data records received from the first network core correspond to a successful user equipment device migration from the first wireless network to the second wireless network: and transmit the plurality of user equipment snapshot data records corresponding to successful user equipment device migrations from the first wireless network to the second wireless network.

System Embodiment 7. The communications system of System Embodiment 6, wherein said operation to determine which of the user equipment snapshot data records received from the first network core correspond to a successful user equipment device migration from the first wireless network to the second wireless network includes: determining a first user equipment snapshot data record for a first user equipment device corresponds to a successful first user equipment device migration from the first wireless network to the second wireless network when a first confirmation message indicating a successful migration from the first wireless network to the second wireless network has been completed is received at the cloud connection manager from the first user equipment device in a first period of time (e.g., 5 minutes after receipt of the first user equipment snapshot data record from the first network core).

System Embodiment 7A. The communications system of System Embodiment 7, wherein said operation to determine which of the user equipment snapshot data records received from the first network core correspond to a successful user equipment device migration from the first wireless network to the second wireless network further includes: determining a first user equipment snapshot data record for a first user equipment device does not correspond to a successful first user equipment device migration from the first wireless network to the second wireless network when a first confirmation message indicating a successful migration from the first wireless network to the second wireless network has been completed is not received at the cloud connection manager from the first user equipment device in the first period of time.

System Embodiment 8. The communications system of System Embodiment 1, wherein the cloud connection manager includes a processor that controls the cloud connection manager to perform the following operations: receive user equipment snapshot data records from the first network core, said user equipment snapshot data records received from the first network core including the plurality of user equipment snapshot data records corresponding to successful user equipment device migrations from the first wireless network to the second wireless network: receive from each user equipment device which has successfully migrated from the first wireless network to the second wireless network a confirmation message indicating the completion of the successful migration of the user equipment device, said confirmation message including information (e.g., user equipment device identification information such as GUTI information and/or session identification information) from which corresponding user equipment snapshot data records can be identified: and identify which of the user equipment snapshot data records received from the first network core correspond to successful migrations of user equipment devices from the first wireless network to the second wireless network using information included in the received confirmation messages and a time when the confirmation message was received at the cloud connection manager.

System Embodiment 9. The communications system of System Embodiment 8, wherein the confirmation messages are received, at the cloud connection manager, from the user equipment devices via the second wireless network.

System Embodiment 9A. The communications system of System Embodiment 8, wherein the confirmation messages are generated by connection manager applications executing on the user equipment devices which have been successfully migrated from the first wireless network to the second wireless network.

System Embodiment 10. The communications system of System Embodiment 1, wherein a first Operations Support System in the first network core receives the first modified OSS data: and performs at least one automated network operation based on the first modified OSS data.

System Embodiment 10A. The communications method of System Embodiment 10, wherein said at least one automated network operation includes one or more of the following: (i) re-allocation of network resources (e.g., modifying spectrum allocations and/or transmit power allocations (e.g., increase transmit power) to one or more wireless base stations in the first wireless network based on actual session drops identified in the modified OSS data occurring in cells of the first wireless network, or (ii) modifying which types of communications sessions are to be migrated from the first wireless network to the second wireless network (e.g., changing the first wireless networks configuration to no longer off-load data sessions of a specific type (e.g., Youtube sessions from a specific IP address, real-time data sessions, or data sessions with a specific quality of service requirement)) from the first wireless network to the second wireless network.

System Embodiment 11. The communications system of System Embodiment 1, wherein session drops are a key performance indicator used for monitoring network performance of the first wireless network: and wherein said first network core includes an Operations Support System that performs an automated network operation (e.g., change in first wireless network configuration, change in transmission power level or change in spectrum assignments for one or more base stations in the first wireless network) to optimize performance of the first wireless network based on the modified session drop information included in the modified first OSS data.

System Embodiment 11A. The communications system of System Embodiment 1, wherein said first OSS data includes key performance indicators used for monitoring the performance of the first wireless network: wherein said modified first OSS data includes modified key performance indicators used for monitoring the performance of the first network: and wherein said modified key performance indicators include: number of sessions dropped by a base station within a time period, number of sessions dropped in each cell within a time period, number of sessions dropped in a cell sector within a time period, data throughput for each cell within a time period, data throughput for each cell sector within a time period, far end server IP addresses with session drops above a first threshold value, number of session drops by cell and session type over a period of time, number of session drops by cell sector and session type over a period of time.

System Embodiment 12. The communications system of System Embodiment 1, wherein said operation to identify one or more false session drops in the first OSS data using the plurality of user equipment snapshot data records and the first plurality of session data records includes: comparing information contained in the user equipment snapshot data records which correspond to a successful UE migration to the session data records which include information on whether or not the session was dropped.

System Embodiment 12A. The communications system of System Embodiment 12, wherein the information contained in the user equipment snapshot data records includes user equipment device identifier information (e.g., Cell Radio Network Temporary Identifier (C-RNTI), Globally Unique Temporary ID (GUTI), International Mobile Subscriber Identity (IMSI), International Mobile Equipment Identity (IMEI) information), time information (e.g., timestamp), location information (e.g., physical location and/or first wireless network cell or cell sector location), and session identifier information (e.g., Packet Data Network (PDN) ID information, Evolved Packet System Bearer Identifier (EPS bearer ID) information, Linked EPS Bearer ID (LBI) information, and Tunnel End Point Identifier (TEID) information).

System Embodiment 13. A communications system comprising: a correlator including: memory, and a first processor, said first processor controlling the correlator to perform the following operations: receive from a cloud connection manager a plurality of user equipment snapshot data records corresponding to successful user equipment device migrations from a first wireless network to a second wireless network: receive from a first network core of a Hybrid Mobile Network Operator (HMNO) wireless system first Operations Support System (OSS) data, said first OSS data including a first plurality of session data records: identify one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying, by the correlator, the first OSS data to mark or remove in the first OSS data the identified false session drops: and communicate the modified first OSS data to the first network core of the HMNO wireless system.

### List of Exemplary Numbered Non-Transitory Computer Readable Medium Embodiments

### Non-transitory Computer Readable Medium Embodiment 1

A non-transitory computer readable medium including a first set of computer executable instructions which when executed by a processor of a correlator cause the correlator to perform the steps of: receiving from a cloud connection manager a plurality of user equipment snapshot data records corresponding to successful user equipment device migrations from a first wireless network to a second wireless network, each of said user equipment snapshot data records including a timestamp, user equipment device identification information, session identification information, and location information: receiving from a first network core of a Hybrid Mobile Network Operator (HMNO) wireless system first Operations Support System (OSS) data, said first OSS data including a first plurality of session data records: identifying one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying the first OSS data to mark or remove in the first OSS data the identified false session drops: and communicating the modified first OSS data to the first network core of the HMNO wireless system.

Non-transitory Computer Readable Medium Embodiment 1A. The non-transitory computer readable medium of Non-transitory Computer Readable Medium Embodiment 1, wherein the first wireless network and second wireless network are operated independently by two different operators.

Non-transitory Computer Readable Medium Embodiment 1A1. The non-transitory computer readable medium of Non-transitory Computer Readable Medium Embodiment 1A, wherein the first wireless network is a Mobile Virtual Network Operator network operated by a first operator (e.g., Verizon) for a second operator (e.g., Charter); wherein the second wireless network is a Multiple System Operator (MSO) network operated by the second operator: and wherein the first wireless network and the second wireless network are operated independently.

Non-transitory Computer Readable Medium Embodiment 1A2. The non-transitory computer readable medium of Non-transitory Computer Readable Medium Embodiment 1, further comprising: a plurality of user equipment devices that are Dual Subscriber Identity Module (SIM) Dual Subscriber (DSDS) user equipment devices with a first SIM and a first subscription for operating on the first wireless network and a second SIM and a second subscription for operating on the second wireless network.

### Non-Transitory Computer Readable Medium Embodiment 1A3

The non-transitory computer readable medium of Non-transitory Computer Readable Medium Embodiment 1A2, wherein the plurality of user equipment devices each include memory, and a processor, said processor controlling the user equipment device in which it is located to transfer active communications sessions from the first wireless network to the second wireless network under a first set of conditions, said first set of conditions including one or more of the following: the location of the user equipment device being within the coverage area of the second wireless network, quality of reference signals (RSRP and/or RSRQ) received by the user equipment device from a base station of the second wireless network, strength of the reference signals (RSRP and/or RSRQ) received by the user equipment device from a base station of the second wireless network, or the type of communications session.

Non-transitory Computer Readable Medium Embodiment 1A4. The non-transitory computer readable medium of Non-transitory Computer Readable Medium Embodiment, wherein user equipment devices of the Hybrid Mobile Network Operator (HMNO) wireless system are Dual Subscriber Identity Module (SIM) Dual Subscriber (DSDS) user equipment devices with a first SIM and a first subscription allowing operation on the first wireless network and a second SIM and a second subscription allowing operation on the second wireless network, each of said DSDS user equipment devices including a connection manager coordinating transfers of the user equipment device communications sessions between the first wireless network and the second wireless network (e.g., transfers or handoffs from the first wireless network to the second wireless network and transfers or handoffs from the second wireless network to the first wireless network).

Non-transitory Computer Readable Medium Embodiment 1A5. The non-transitory computer readable medium of Non-transitory Computer Readable Medium Embodiment 1A, wherein the first wireless network is a Multiple System Operator (MSO) network operated by a first operator (e.g., Charter): wherein the second wireless network is a Mobile Virtual Network Operator network operated by a second operator (e.g., Verizon) for the first operator (e.g., Charter): and wherein the first wireless network and the second wireless network are operated independently.

Non-transitory Computer Readable Medium Embodiment 1B. The non-transitory computer readable medium of Non-transitory Computer Readable Medium Embodiment 1, wherein the first wireless network is a large cell wireless network and the second wireless network is a small cell wireless network; and wherein a plurality of the second wireless network cells are encompassed by cells of the first wireless network.

### Non-Transitory Computer Readable Medium Embodiment 2

A non-transitory computer readable medium including a first set of computer executable instructions which when executed by a processor of a correlator cause the correlator to perform the steps of: receiving from a cloud connection manager a plurality of user equipment snapshot data records corresponding to successful user equipment device migrations from a first wireless network to a second wireless network: receiving from a first network core of a Hybrid Mobile Network Operator (HMNO) wireless system first Operations Support System (OSS) data, said first OSS data including a first plurality of session data records: identifying one or more false session drops in the first OSS data using the plurality of user equipment snapshot data records and the first plurality of session data records (e.g., by comparing information (e.g., user equipment device identifier information, time information, location information, and/or session identifier information) contained in the user equipment snapshot data records which correspond to a successful UE migration to the session data records which include information on whether or not the session was dropped): modifying the first OSS data to mark or remove in the first OSS data the identified false session drops: and communicating the modified first OSS data to the first network core of the HMNO wireless system.

The techniques of various embodiments may be implemented using software, hardware and/or a combination of software and hardware. Various embodiments are directed to apparatus, e.g., wireless base stations, wireless devices, mobile terminals, network equipment, communications devices, eNBs, gNBs, CBSDs, collelators, Operations Support Systems, cloud connection managers, mobility management entities, HSS systems, smart devices, user equipment devices, computers, smartphones, wireless networks, subscriber devices, network cores, EPCs, servers, nodes, and/or elements. Various embodiments are also directed to methods, e.g., method of controlling and/or operating wireless base stations, wireless devices, mobile terminals, network equipment, communications devices, eNBs, gNBs, CBSDs, collelators, Operations Support Systems, cloud connection managers, mobility management entities, HSS systems, smart devices, user equipment devices, computers, smartphones, wireless networks, subscriber devices, network cores, EPCs, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the described methods.

In various embodiments each of the steps or elements of a method are implemented using one or more processors. In some embodiments, each of elements or steps are implemented using hardware circuitry.

In various embodiments devices, e.g., wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements described herein are implemented using one or more components to perform the steps corresponding to one or more methods, for example, generating or creating UE snapshot records, OSS data/information, session data records, generating messages, comparing data and information, signal processing, sending, comparing, identifying, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements are configured to perform the steps of the methods described as being performed by the wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements, with a processor which includes a component corresponding to each of the steps of the various described methods performed by the device in which the processor is included. In some but not all embodiments a device, e.g., wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., wireless base stations, wireless devices, mobile terminals, network equipment, communications devices, eNBs, gNBs, CBSDs, correlators, Operations Support Systems, cloud connection managers, mobility management entities, HSS systems, smart devices, user equipment devices, computers, smartphones, wireless networks, subscriber devices, network cores, EPCs, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as wireless base station, wireless device, mobile terminal, network equipment, communications device, eNB, gNB, CBSD, correlator, Operations Support System, cloud connection manager, mobility management entity, HSS system, smart device, user equipment device, computer, smartphone, wireless network, subscriber device, network core, EPC, server, node, and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method comprising:
receiving at a correlator from a cloud connection manager a plurality of user equipment snapshot data records corresponding to successful user equipment device migrations from a first wireless network to a second wireless network;
receiving, by the correlator, from a first network core of a Hybrid Mobile Network Operator (HMNO) wireless system first Operations Support System (OSS) data, said first OSS data including a first plurality of session data records;
identifying one or more false session drops in the first OSS data using the plurality of user equipment snapshot data records and the first plurality of session data records;
modifying, by the correlator, the first OSS data to mark or remove in the first OSS data the identified false session drops; and
communicating, by the correlator, the modified first OSS data to the first network core of the HMNO wireless system.

2. The communications method of claim 1 further comprising:
prior to receiving at the correlator from the cloud connection manager the plurality of user equipment snapshot data records corresponding to successful user equipment device migrations from the first wireless network to the second wireless network,
generating a first user equipment snapshot data record at the first network core based on information received from a first user equipment device connected to a first base station of the first wireless network at a first time, said first user equipment snapshot data record being one of the plurality of user equipment snapshot data records corresponding to successful user equipment device migrations from the first wireless network to the second wireless network; and
transmitting the first user equipment snapshot data record from the first network core to the cloud connection manager.

3. The communications method of claim 2, further comprising:
prior to generating the first user equipment snapshot data record at the first network core based on information received from the first user equipment device connected to the first base station of the first wireless network at the first time,
determining at the first network core to generate the first user equipment snapshot data record based on one or more of the following: location information received from the first user equipment device or signaling information received from the first user equipment device.

4. The communications method of claim 3,
wherein determining at the first network core to generate the first user equipment snapshot data record based on one or more of the following: location information received from the first user equipment device or signaling information received from the first user equipment device includes: determining to generate the first user equipment snapshot data record when a first criteria is met.

5. The communications method of claim 4, wherein the first criteria is met when at least one of the following is true: the location information received from the first user equipment device indicates the first user equipment device is within a first distance of a perimeter of the wireless coverage area of the second wireless network or the signaling information received from the first user equipment device is below a first threshold level.

6. The communications method of claim 1, further comprising:
prior to receiving at the correlator from the cloud connection manager a plurality of user equipment snapshot data records corresponding to successful user equipment device migrations from a first wireless network to a second wireless network,
receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network;
determining, at the cloud connection manager, which of the user equipment snapshot data records received from the first network core correspond to a successful user equipment device migration from the first wireless network to the second wireless network; and
transmitting the plurality of user equipment snapshot data records corresponding to successful user equipment device migrations from the first wireless network to the second wireless network.

7. The communications method of claim 6,
wherein said determining, at the cloud connection manager, which of the user equipment snapshot data records received from the first network core correspond to a successful user equipment device migration from the first wireless network to the second wireless network includes:
determining a first user equipment snapshot data record for a first user equipment device corresponds to a successful first user equipment device migration from the first wireless network to the second wireless network when a first confirmation message indicating a successful migration from the first wireless network to the second wireless network has been completed is received at the cloud connection manager from the first user equipment device in a first period of time.

8. The communications method of claim 1, further comprising:
receiving, at the cloud connection manager, user equipment snapshot data records from the first network core, said user equipment snapshot data records received from the first network core including the plurality of user equipment snapshot data records corresponding to successful user equipment device migrations from the first wireless network to the second wireless network;
receiving, at the connection manager, from each user equipment device which has successfully migrated from the first wireless network to the second wireless network a confirmation message indicating the completion of the successful migration of the user equipment device, said confirmation message including information from which corresponding user equipment snapshot data records can be identified; and
identifying, at the cloud connection manager, which of the user equipment snapshot data records received from the first network core correspond to successful migrations of user equipment devices from the first wireless network to the second wireless network using information included in the received confirmation messages and a time when the confirmation message was received at the cloud connection manager.

9. The communications method of claim 8,
wherein the confirmation messages are received, at the cloud connection manager, from the user equipment devices via the second wireless network.

10. The communications method of claim 1,
wherein each of said user equipment snapshot data records includes a timestamp, user equipment device identification information, session identification information, and location information;
wherein session drops are a key performance indicator used for monitoring network performance of the first wireless network; and
wherein the communications method further includes:
implementing, by an Operations Service System of the first network core an automated network operation to optimize performance of the first wireless network based on the modified session drop information included in the modified first OSS data.

11. The communications method of claim 1,
wherein said identifying one or more false session drops in the first OSS data using the plurality of user equipment snapshot data records and the first plurality of session data records includes:
comparing information contained in the user equipment snapshot data records which correspond to a successful user equipment device migration to the session data records which include information on whether or not the session was dropped.

12. The communications method of claim 1,
wherein the first wireless network is a Mobile Virtual Network Operator network operated by a first operator for a second operator;
wherein the second wireless network is a Multiple System Operator (MSO) network operated by the second operator; and
wherein the first wireless network and the second wireless network are operated independently.

13. A communications system comprising:
a correlator including:
memory, and
a first processor, said first processor controlling the correlator to perform the following operations:
receive from a cloud connection manager a plurality of user equipment snapshot data records corresponding to successful user equipment device migrations from a first wireless network to a second wireless network;
receive from a first network core of a Hybrid Mobile Network Operator (HMNO) wireless system first Operations Support System (OSS) data, said first OSS data including a first plurality of session data records;
identify one or more false session drops in the first OSS data using the plurality of user equipment snapshot data records and the first plurality of session data records;
modifying, by the correlator, the first OSS data to mark or remove in the first OSS data the identified false session drops; and
communicate the modified first OSS data to the first network core of the HMNO wireless system.

14. The communications system of claim 13,
wherein prior to the correlator receiving from the cloud connection manager the plurality of user equipment snapshot data records corresponding to successful user equipment device migrations from the first wireless network to the second wireless network, an entity in first network core performs the operations of:
generating a first user equipment snapshot data record based on information received from a first user equipment device connected to a first base station of the first wireless network at a first time, said first user equipment snapshot data record being one of the plurality of user equipment snapshot data records corresponding to successful user equipment device migrations from the first wireless network to the second wireless network; and
transmitting the first user equipment snapshot data record from the first network core to the cloud connection manager.

15. The communications system of claim 14,
wherein prior to the first user equipment snapshot data record being generated, said entity in the first network core determining to generate the first user equipment snapshot data record based on one or more of the following: location information received from the first user equipment device or signaling information received from the first user equipment device.

16. The communications system of claim 13,
wherein prior to receiving at the correlator from the cloud connection manager a plurality of user equipment snapshot data records corresponding to successful user equipment device migrations from a first wireless network to a second wireless network, the cloud connection is operated by a processor included in the cloud connection manager to perform the following operations:
receive user equipment snapshot data records from the first network core, said user equipment snapshot data records received from the first network core including the plurality of user equipment snapshot data records corresponding to successful user equipment device migrations from the first wireless network to the second wireless network;
determine which of the user equipment snapshot data records received from the first network core correspond to a successful user equipment device migration from the first wireless network to the second wireless network; and
transmit the plurality of user equipment snapshot data records corresponding to successful user equipment device migrations from the first wireless network to the second wireless network.

17. The communications system of claim 13,
wherein the cloud connection manager includes a processor that controls the cloud connection manager to perform the following operations;
receive user equipment snapshot data records from the first network core, said user equipment snapshot data records received from the first network core including the plurality of user equipment snapshot data records corresponding to successful user equipment device migrations from the first wireless network to the second wireless network;
receive from each user equipment device which has successfully migrated from the first wireless network to the second wireless network a confirmation message indicating the completion of the successful migration of the user equipment device, said confirmation message including information from which corresponding user equipment snapshot data records can be identified; and
identify which of the user equipment snapshot data records received from the first network core correspond to successful migrations of user equipment devices from the first wireless network to the second wireless network using information included in the received confirmation messages and a time when the confirmation message was received at the cloud connection manager.

18. The communications system of claim 13,
wherein each of said user equipment snapshot data records includes a timestamp, user equipment device identification information, session identification information, and location information;
wherein session drops are a key performance indicator used for monitoring network performance of the first wireless network; and
wherein said first network core includes an Operations Support System that performs an automated network operation to optimize performance of the first wireless network based on the modified session drop information included in the modified first OSS data.

19. The communications system of claim 13,
wherein said operation to identify one or more false session drops in the first OSS data using the plurality of user equipment snapshot data records and the first plurality of session data records includes:
comparing information contained in the user equipment snapshot data records which correspond to a successful UE migration to the session data records which include information on whether or not the session was dropped.

20. A non-transitory computer readable medium including a first set of computer executable instructions which when executed by a processor of a correlator cause the correlator to perform the steps of:
receiving from a cloud connection manager a plurality of user equipment snapshot data records corresponding to successful user equipment device migrations from a first wireless network to a second wireless network;
receiving from a first network core of a Hybrid Mobile Network Operator (HMNO) wireless system first Operations Support System (OSS) data, said first OSS data including a first plurality of session data records;
identifying one or more false session drops in the first OSS data using the plurality of user equipment snapshot data records and the first plurality of session data records;
modifying the first OSS data to mark or remove in the first OSS data the identified false session drops; and
communicating the modified first OSS data to the first network core of the HMNO wireless system.
